(19) United States
(12) Patent Application Publication
(10) Pub. No.: US 2004/0073611 A1
(43) Pub. Date: Apr. 15, 2004

(54) Methods and apparatus for facilitating the provision of services

(76) Inventor: Lindsay T. Atwood, South Jordan, UT (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/378,734

(22) Filed: Mar. 3, 2003

Related U.S. Application Data
(60) Provisional application No. 60/360,795, filed on Mar. 1, 2002.

(51) Int. Cl. G06F 15/16; G06F 17/30; G06F 7/00

(52) U.S. Cl. 709/204; 709/217; 707/3

(57) ABSTRACT

This invention is directed toward business models and Web-based systems for providing interactive web-based services between a company and optometrists/ophthalmologists. This web-based system could also be used to connect a wide range of business professionals in a variety of industries. “Web-based systems” include systems that comprise one or more sites on a global network (e.g., one or more sites on the World Wide Web portion of the Internet).

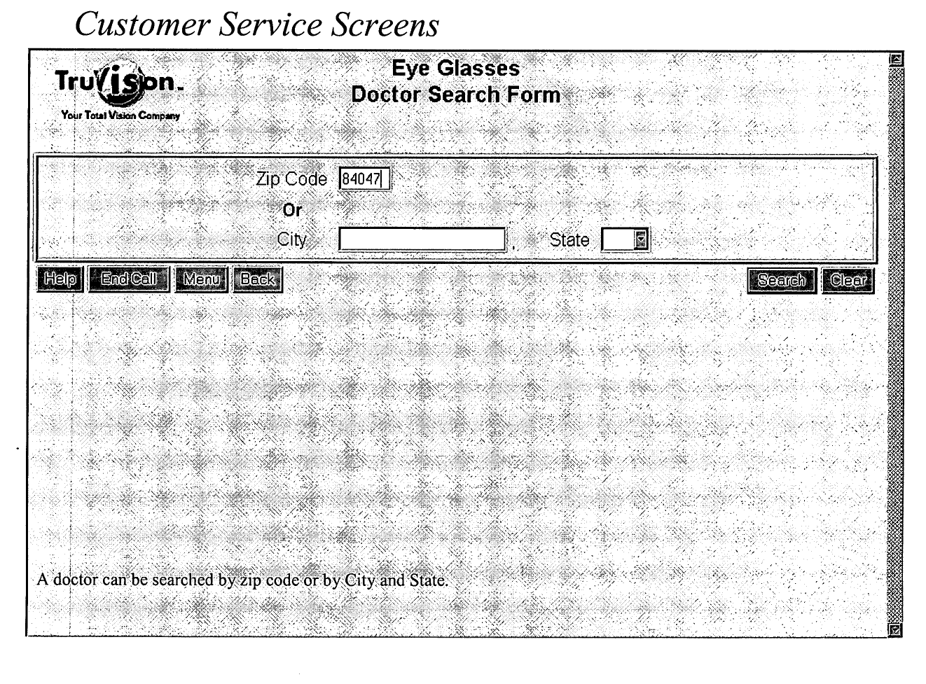

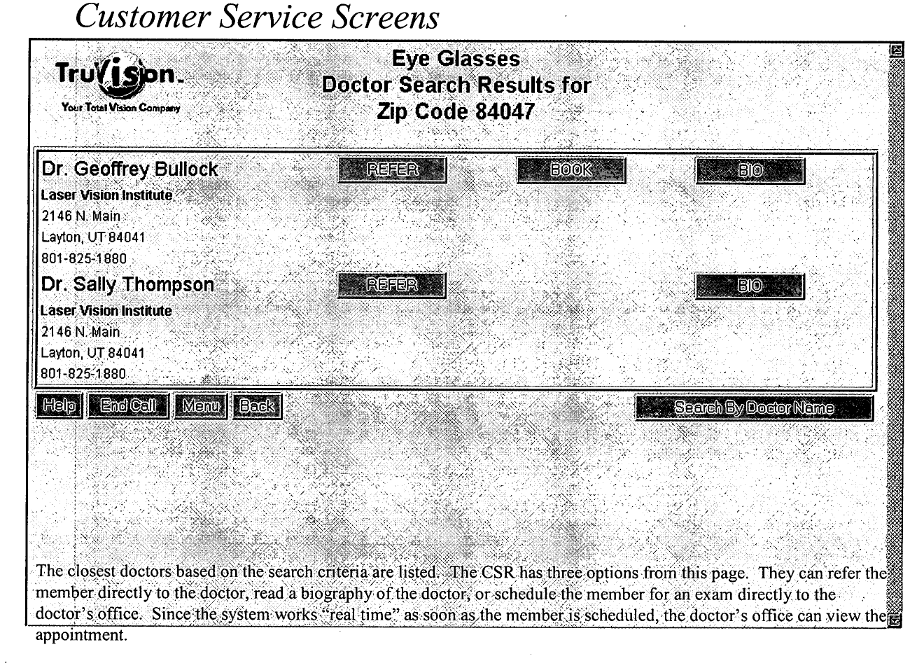

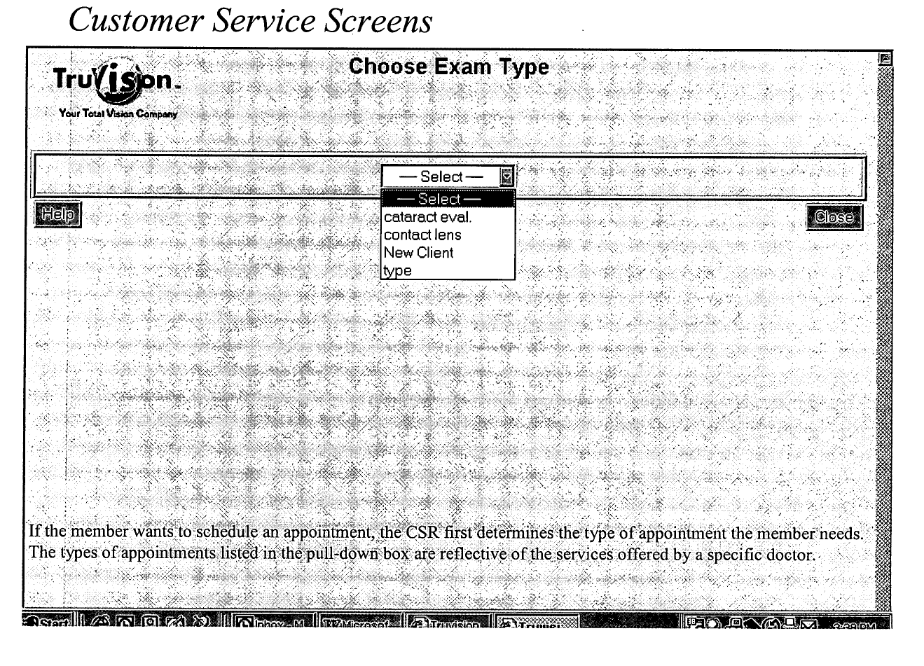

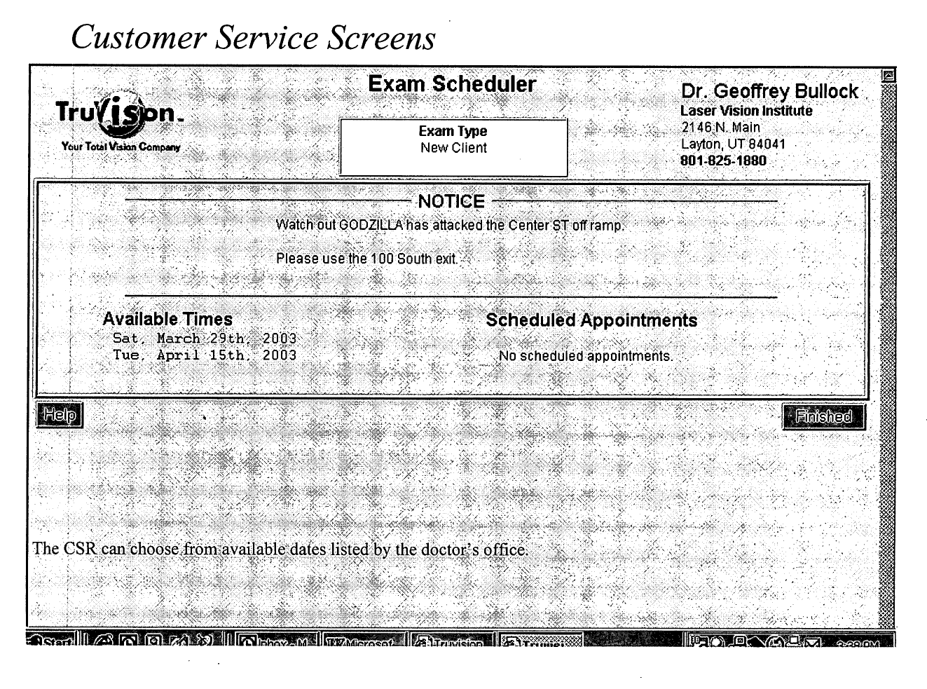

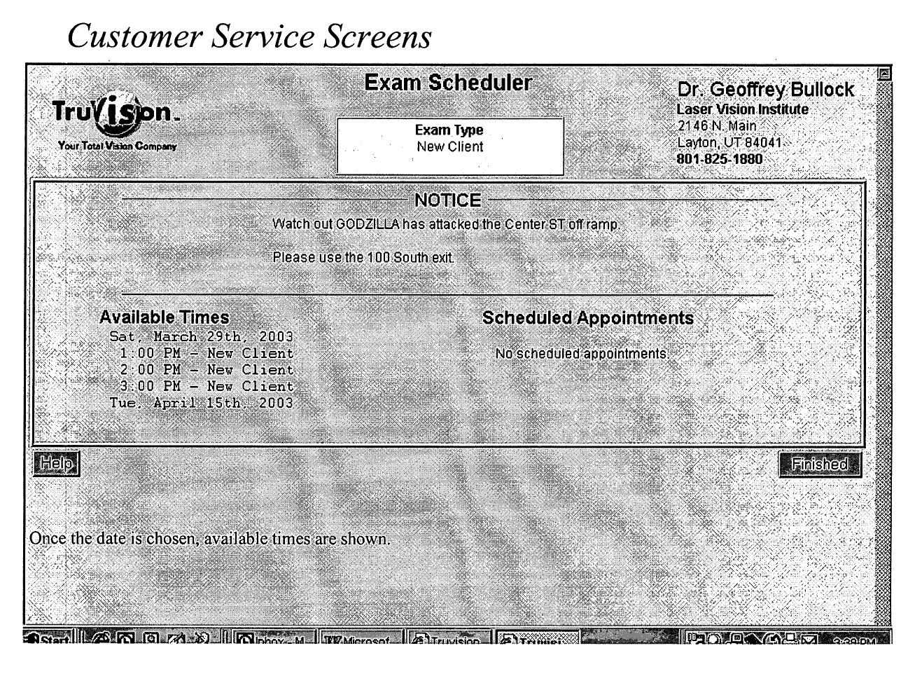

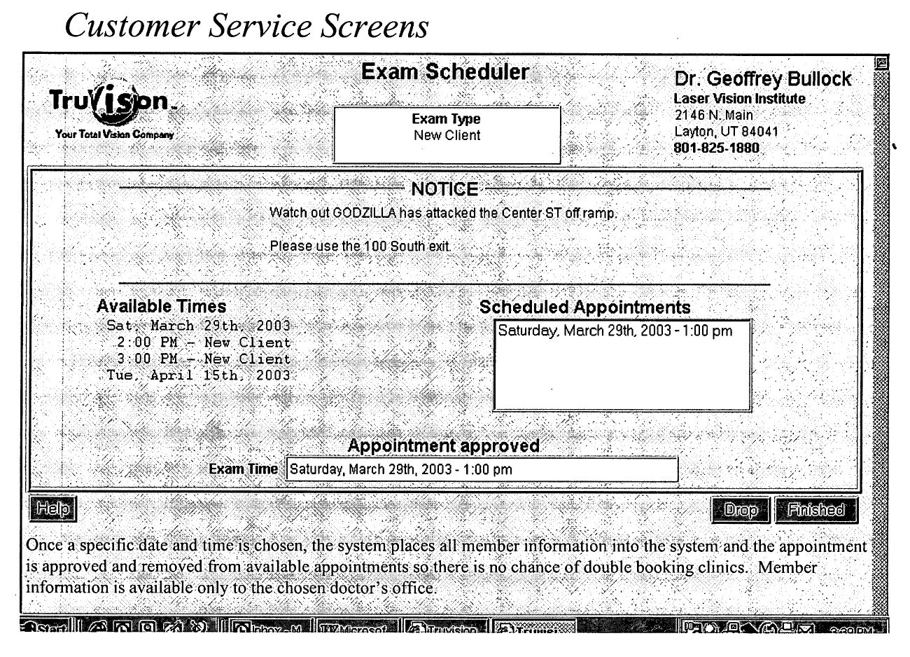

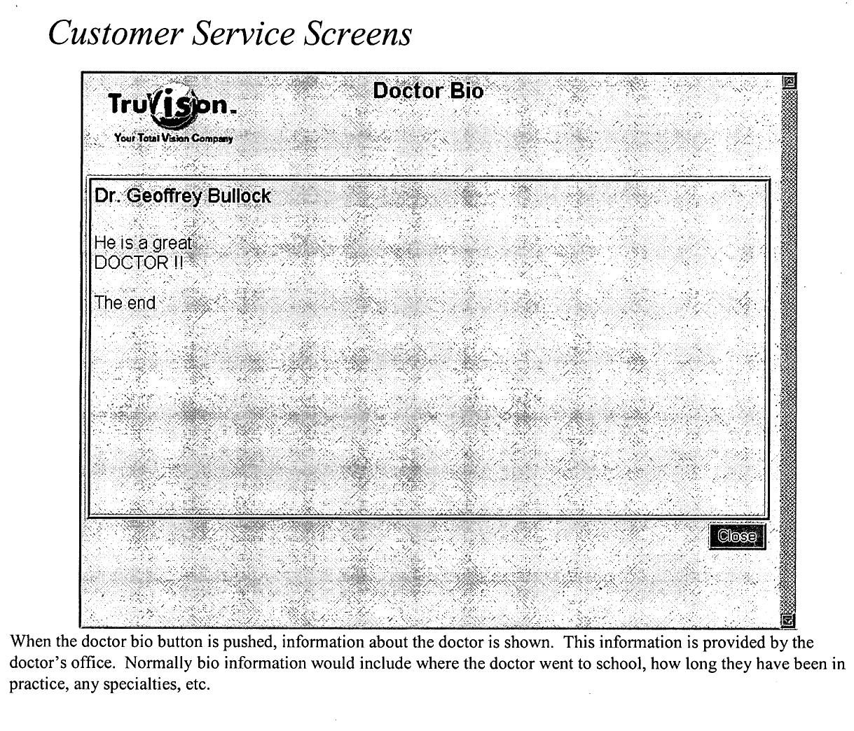

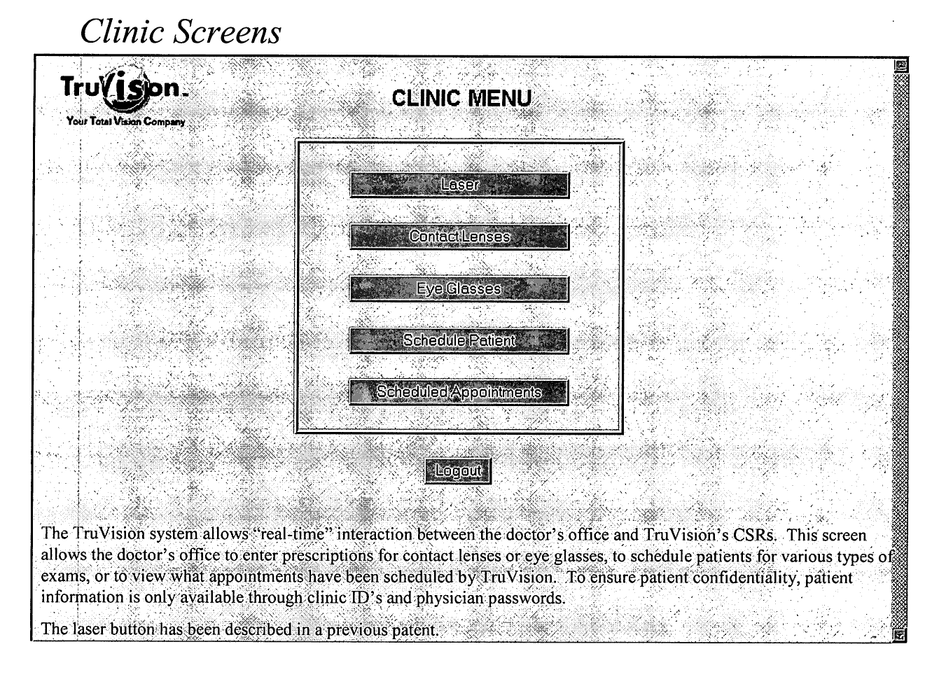

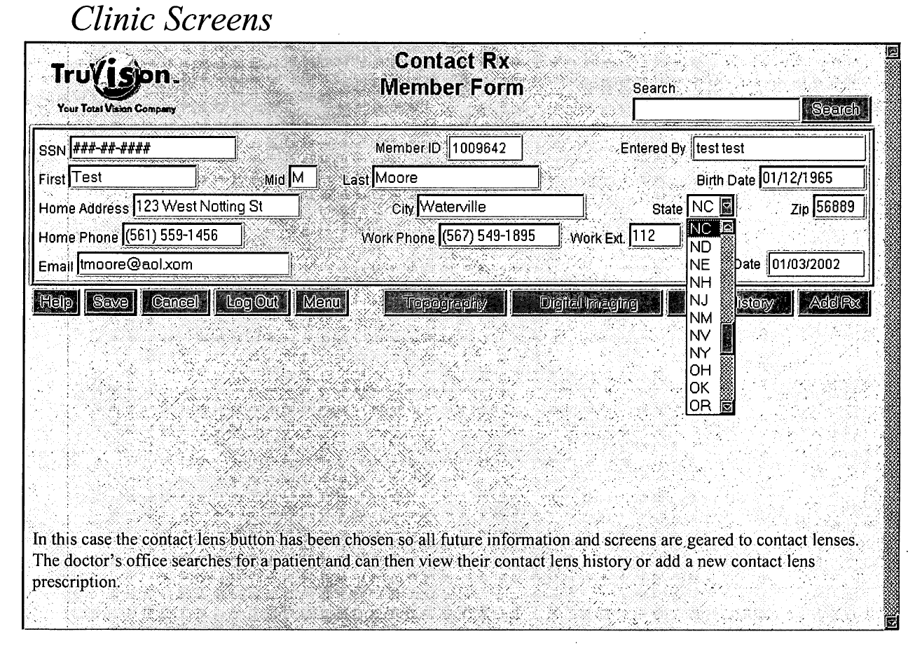

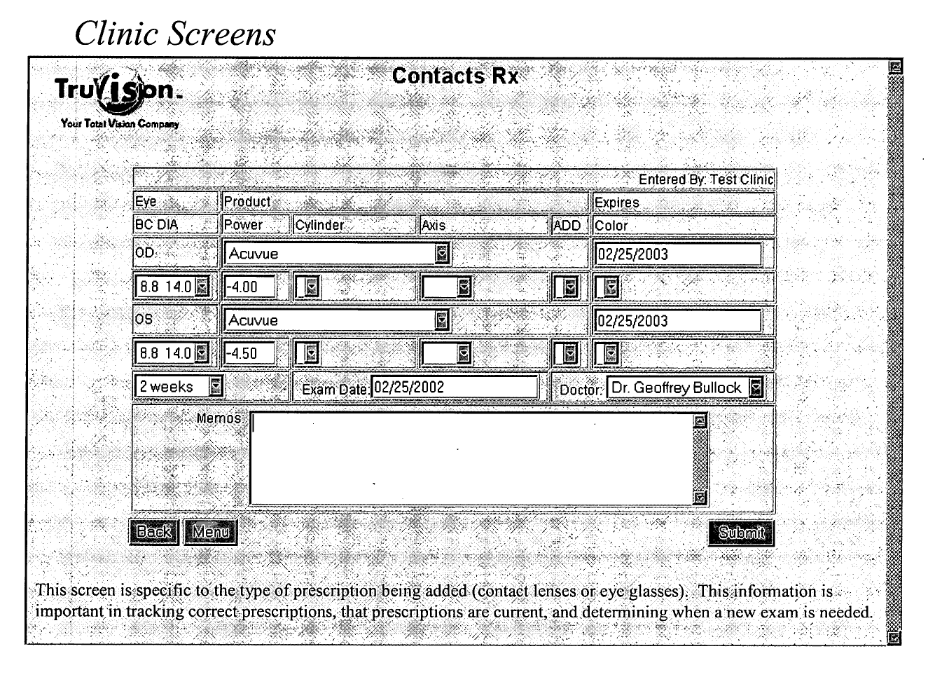

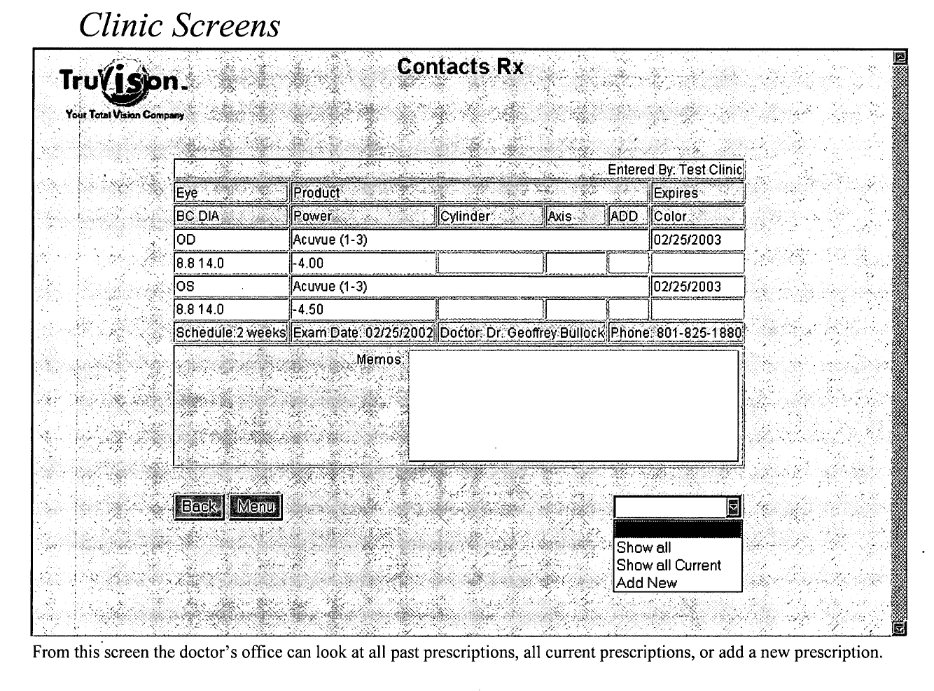

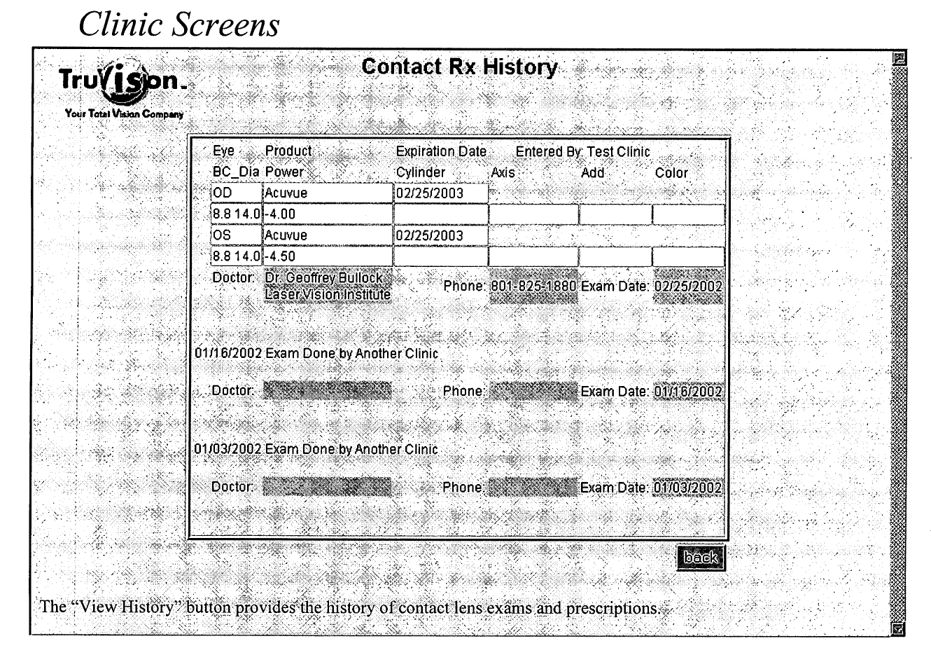

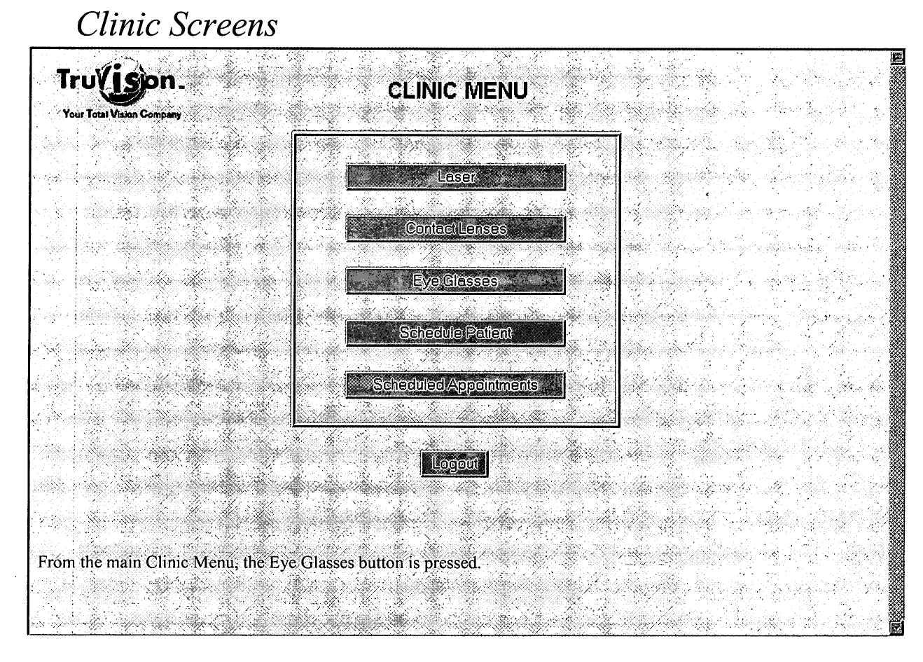

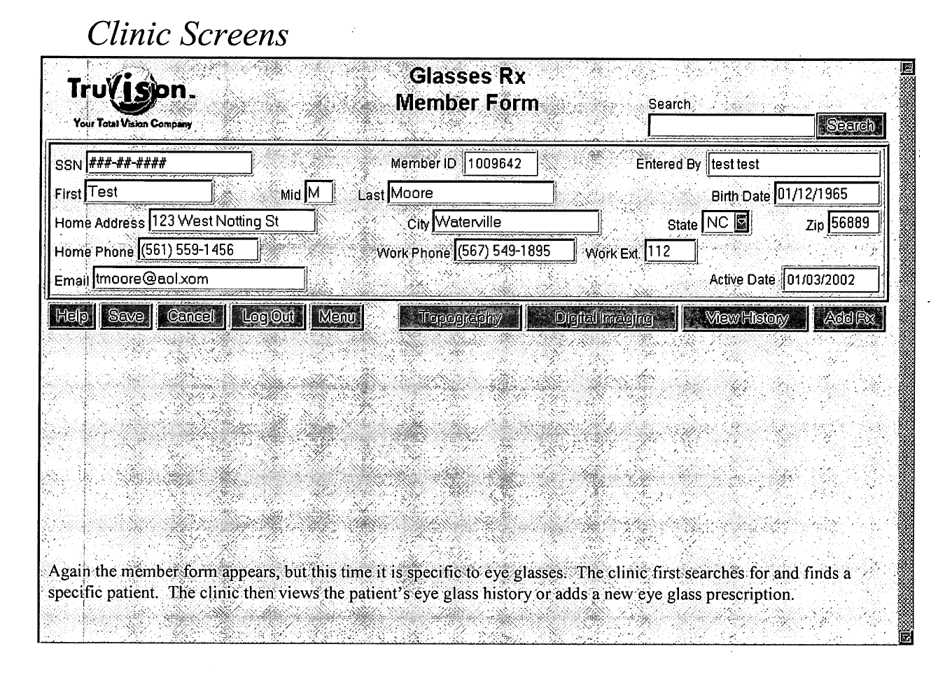

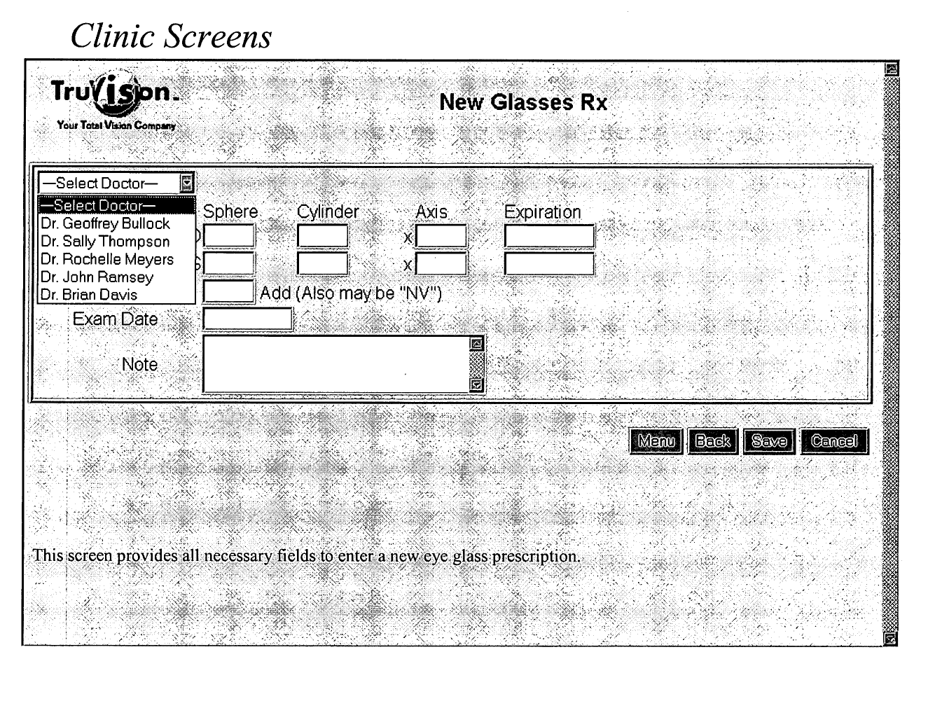

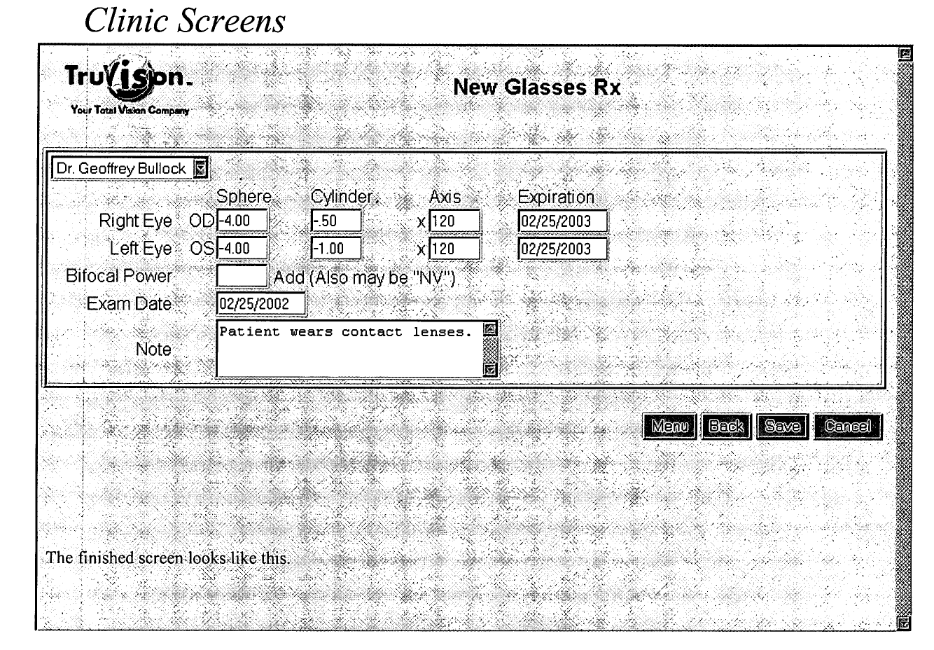

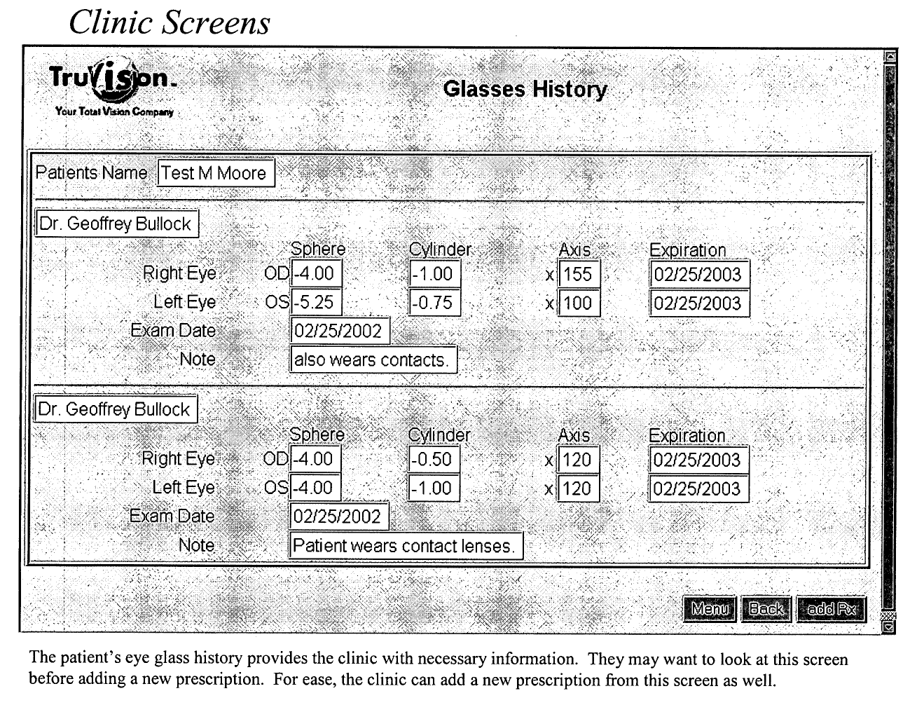

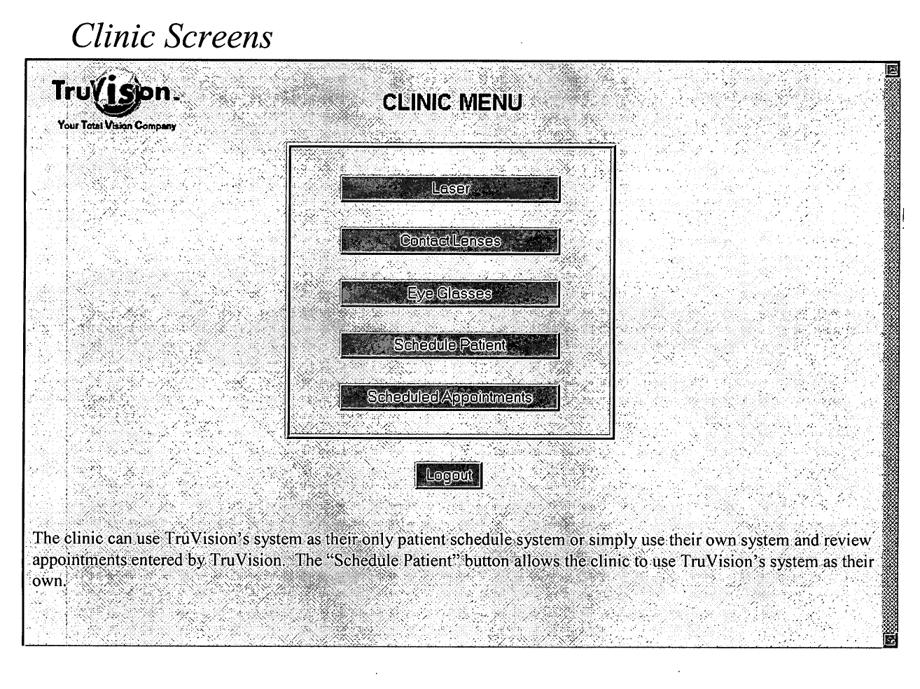

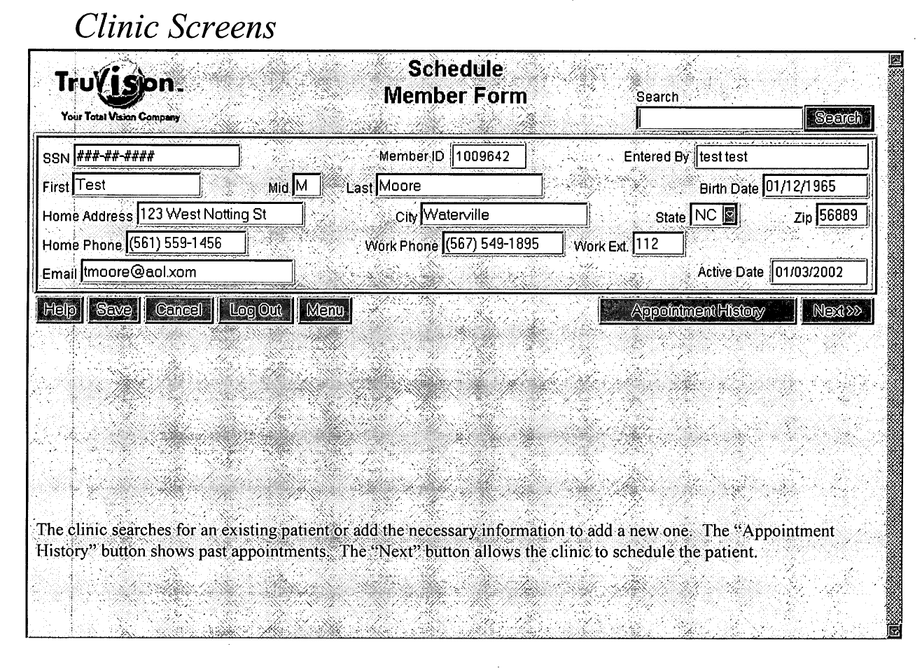

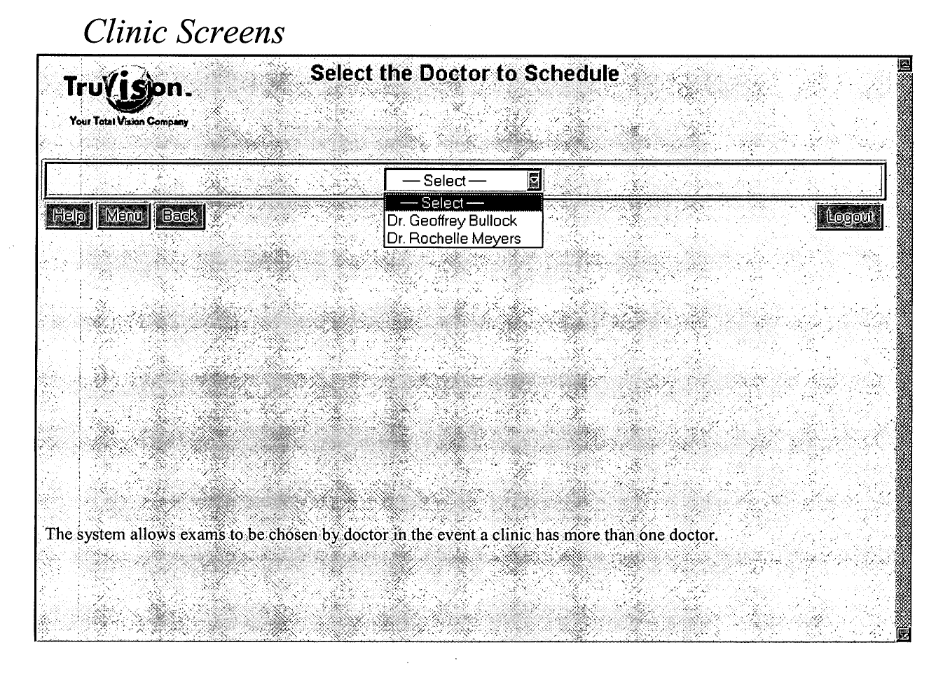

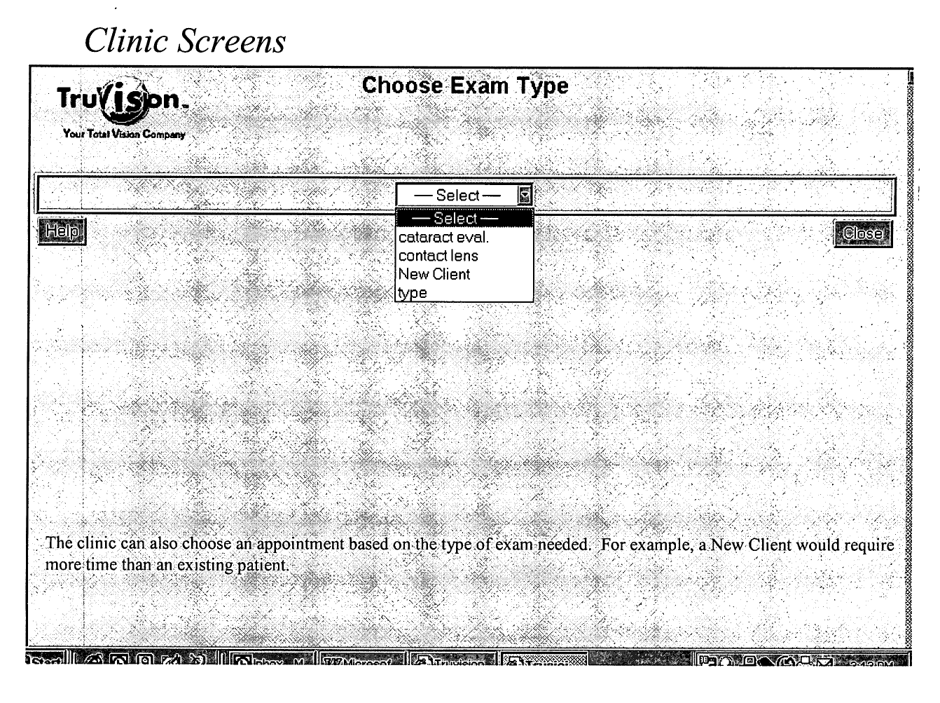

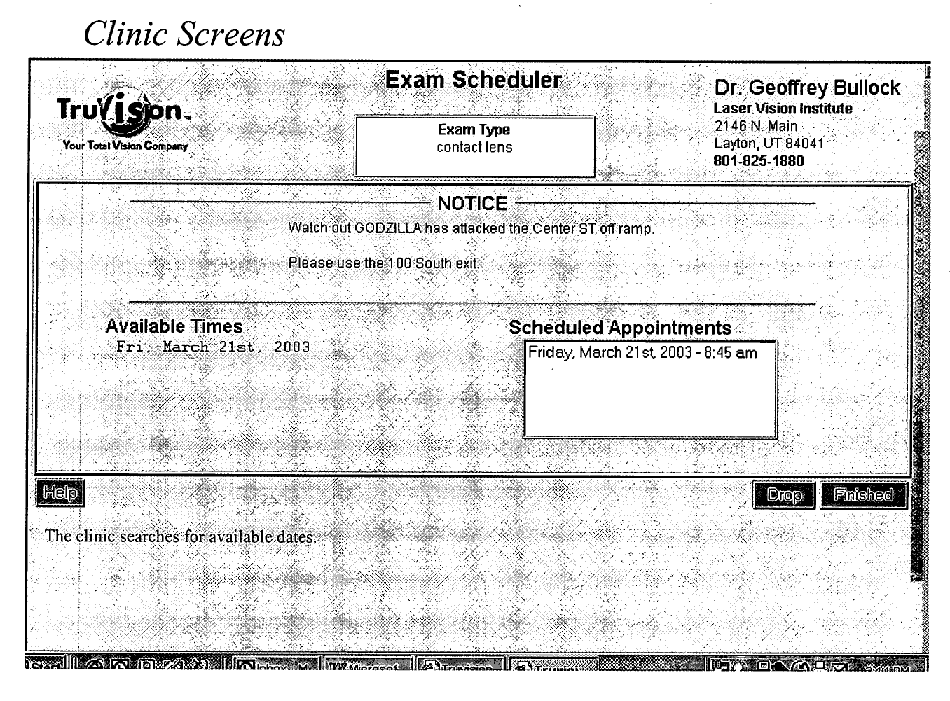

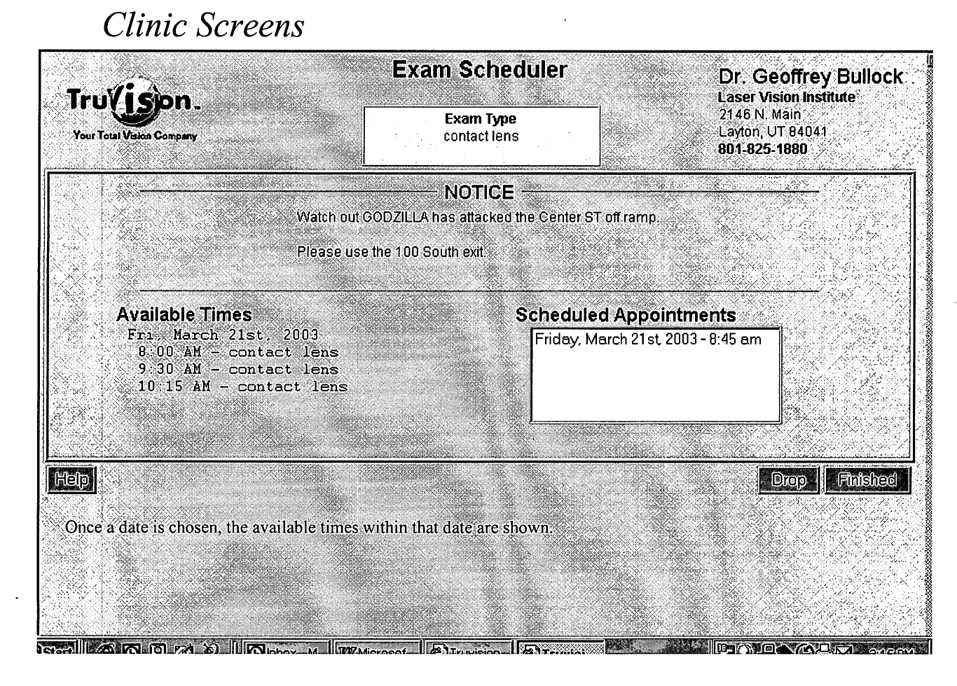

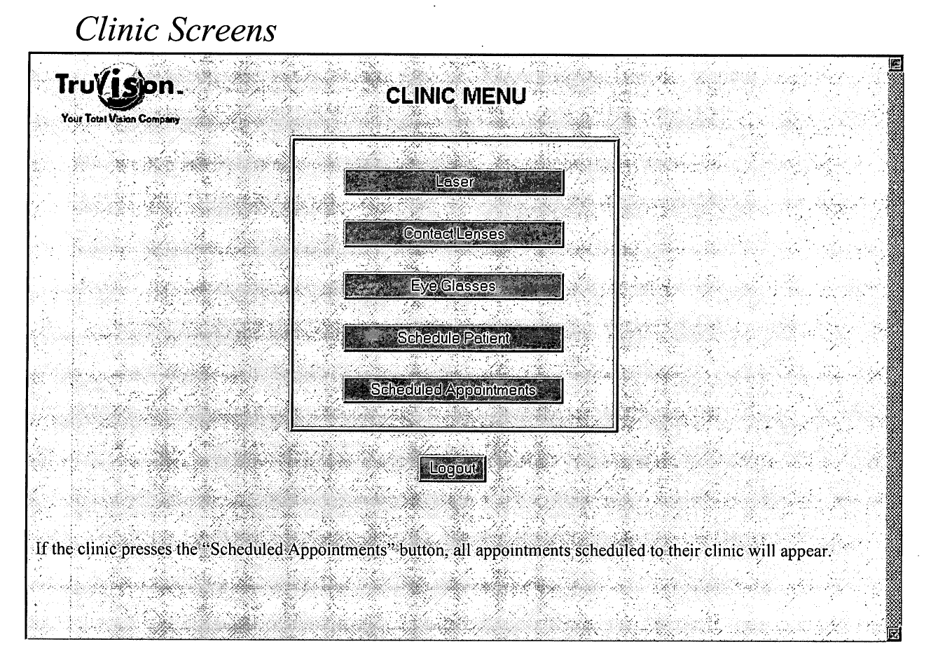

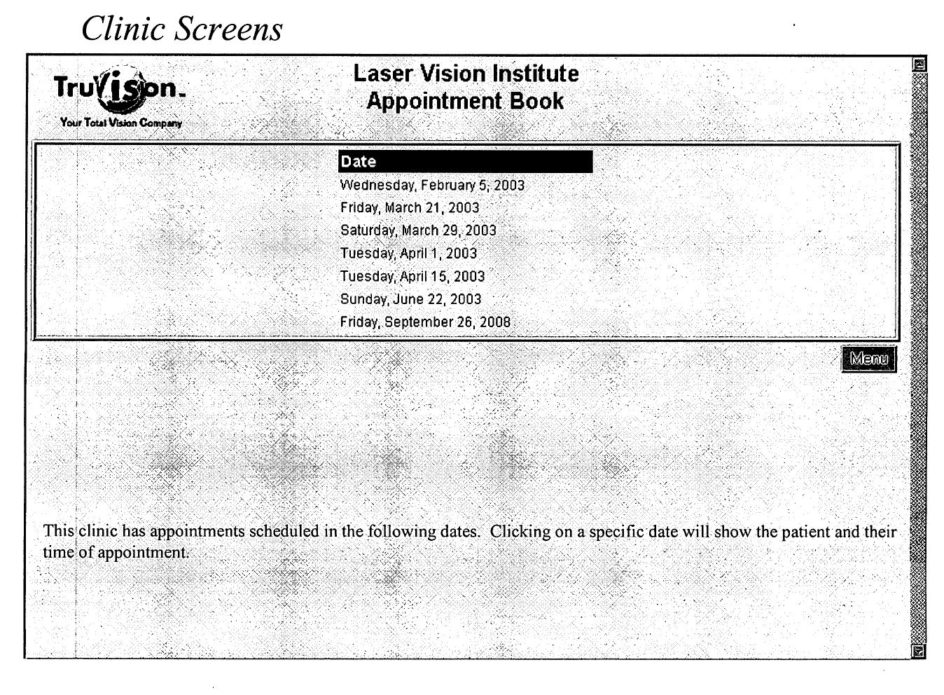

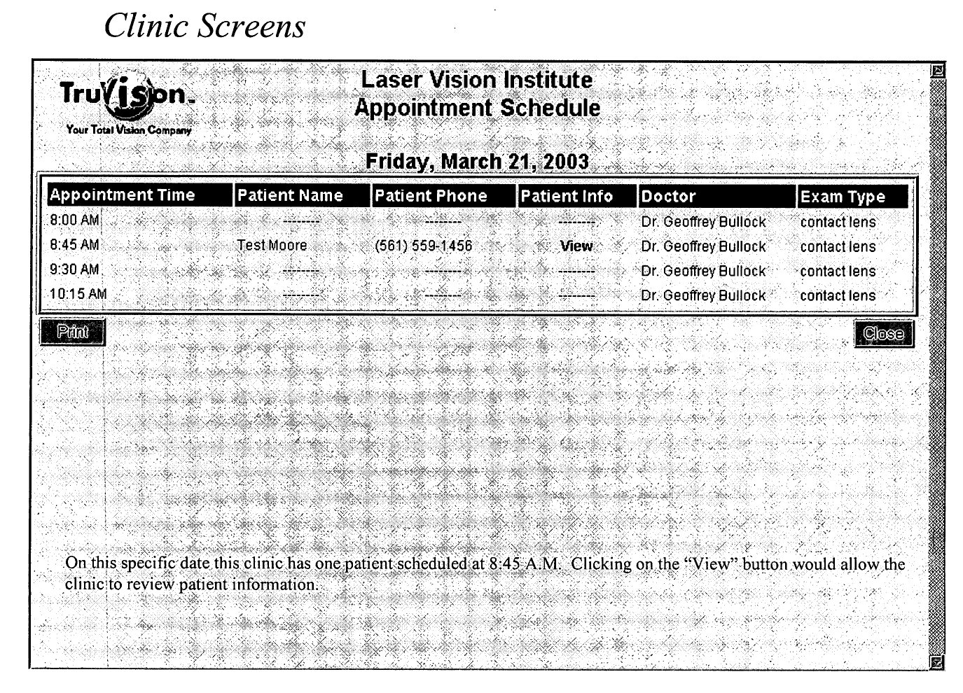

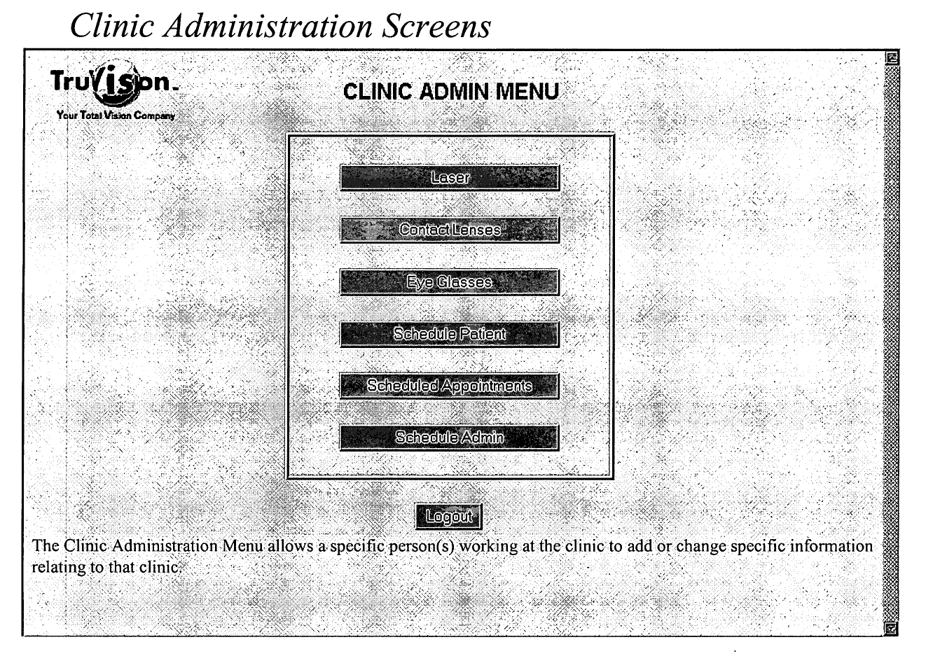

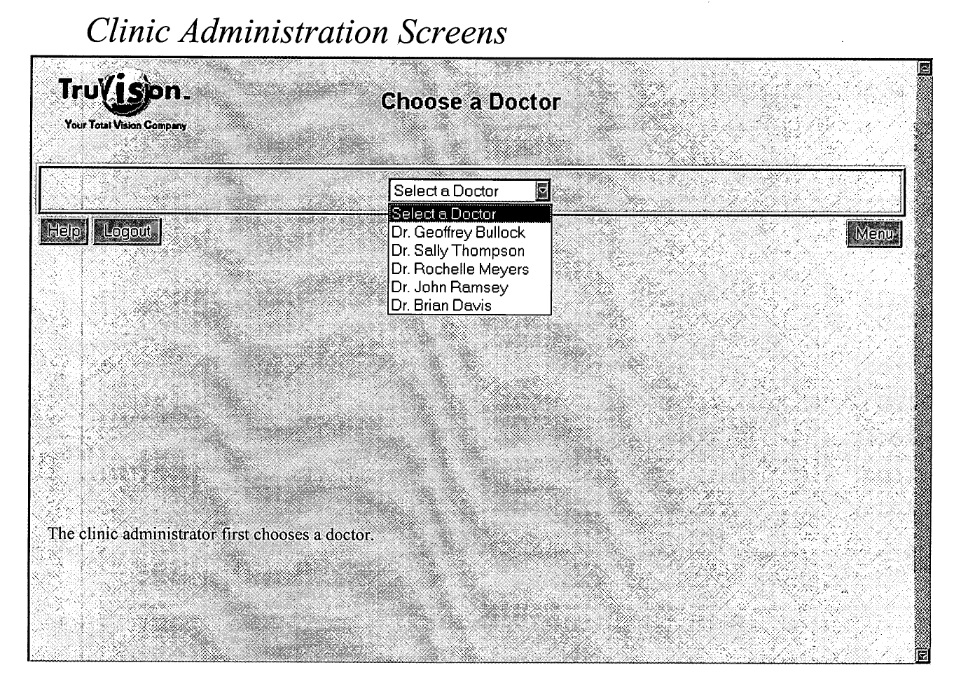

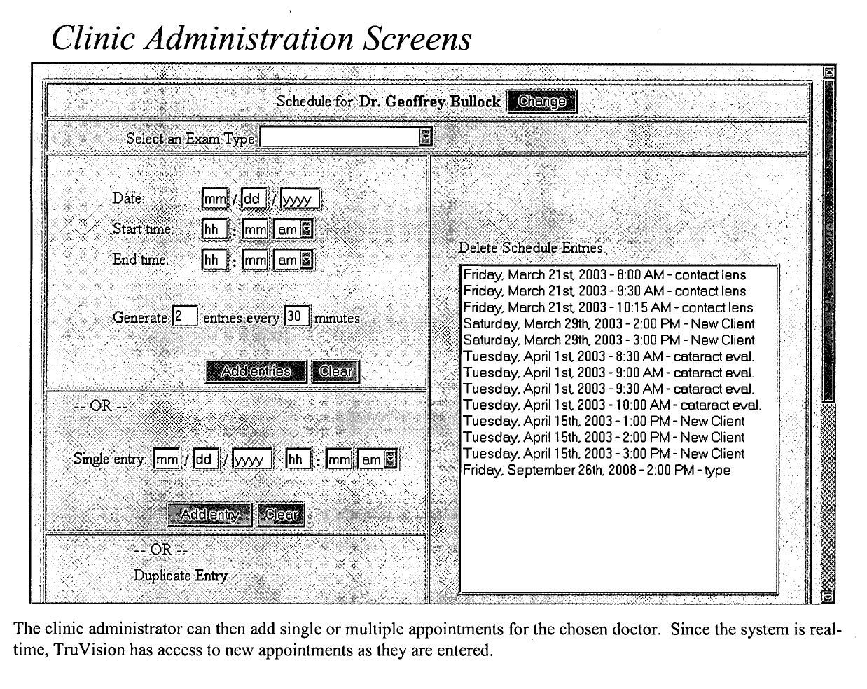

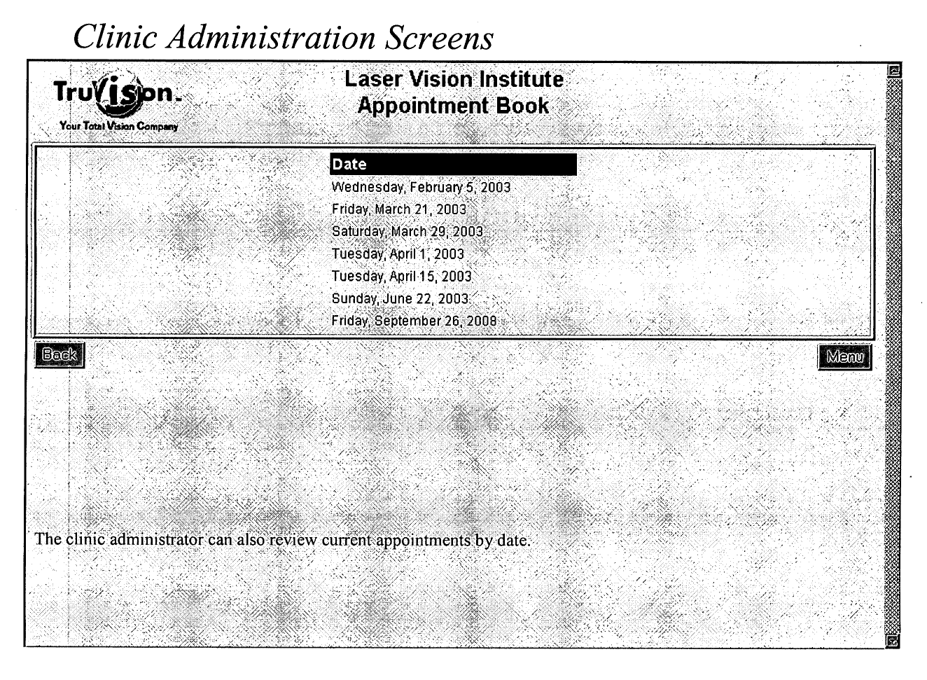

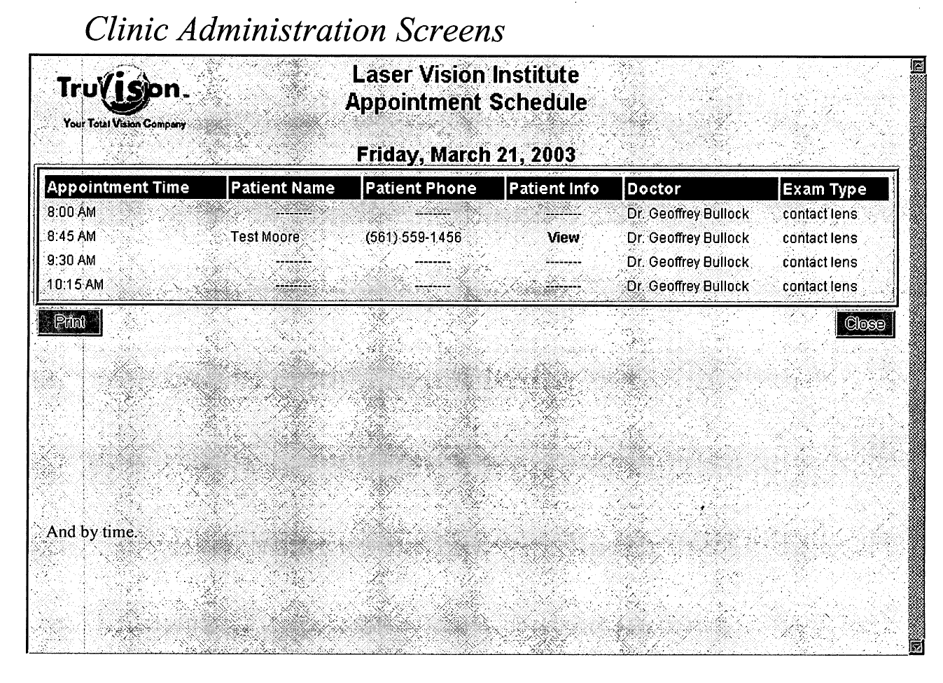

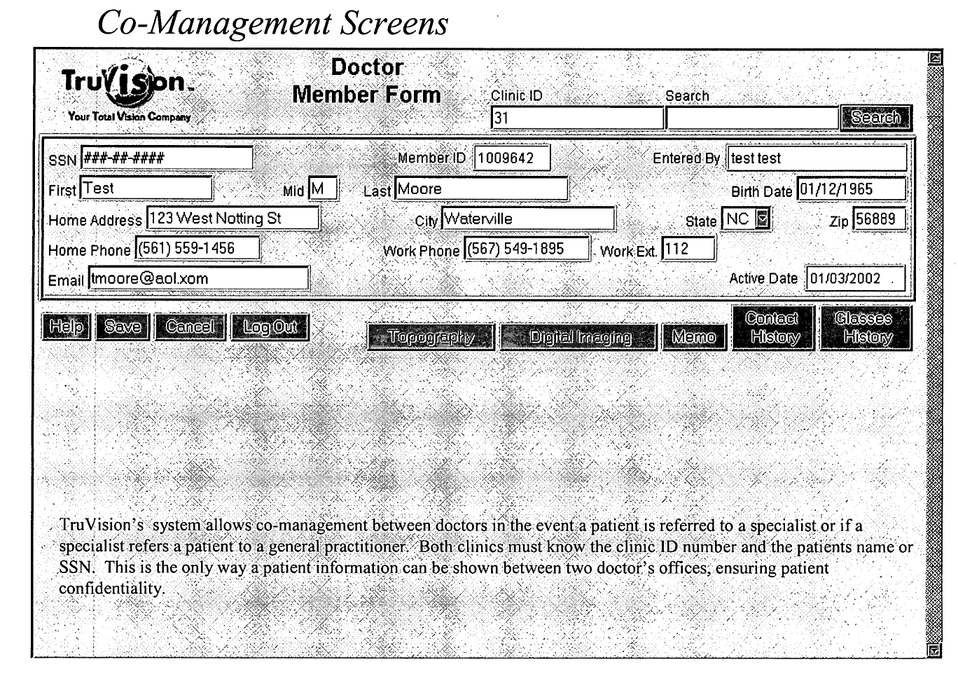

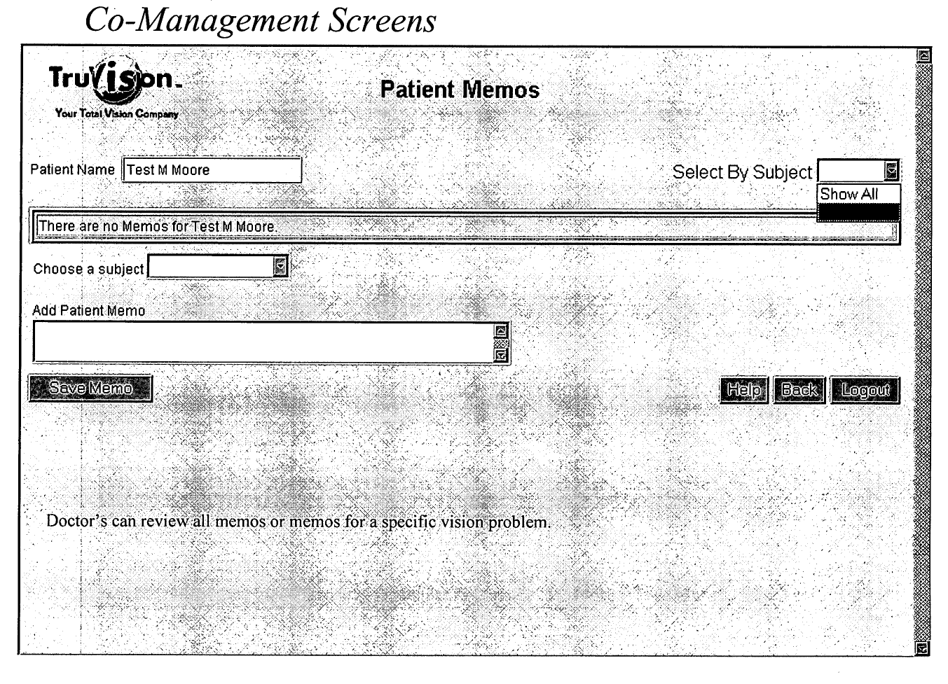

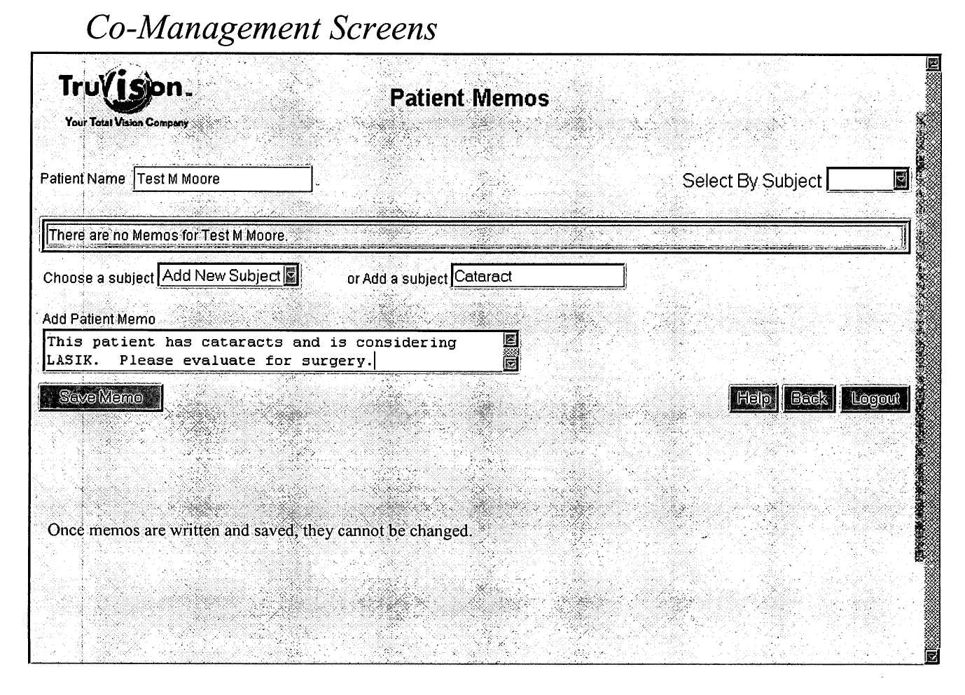

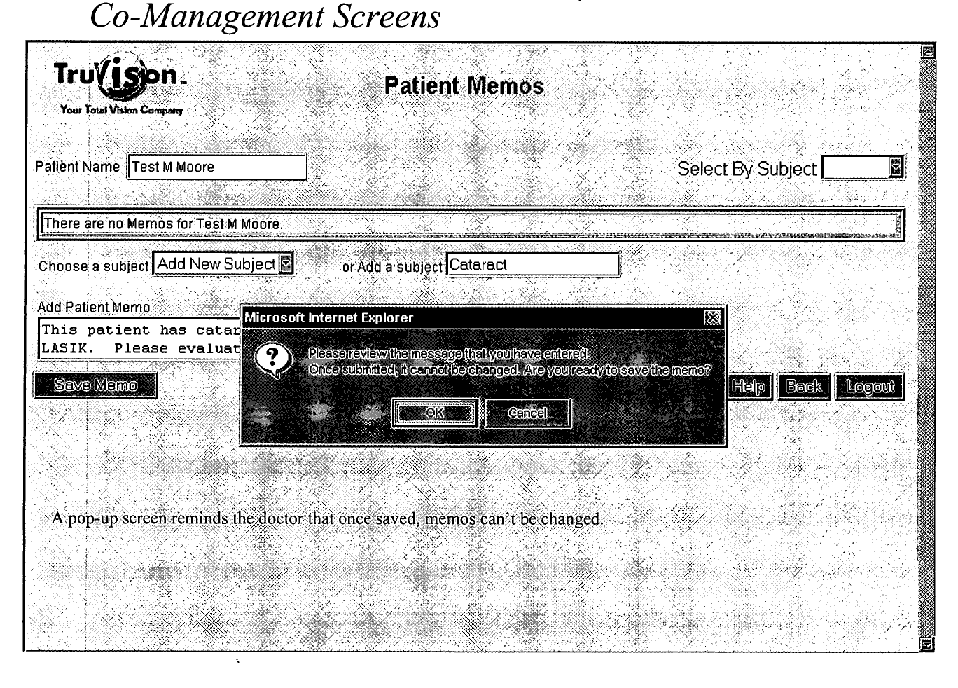

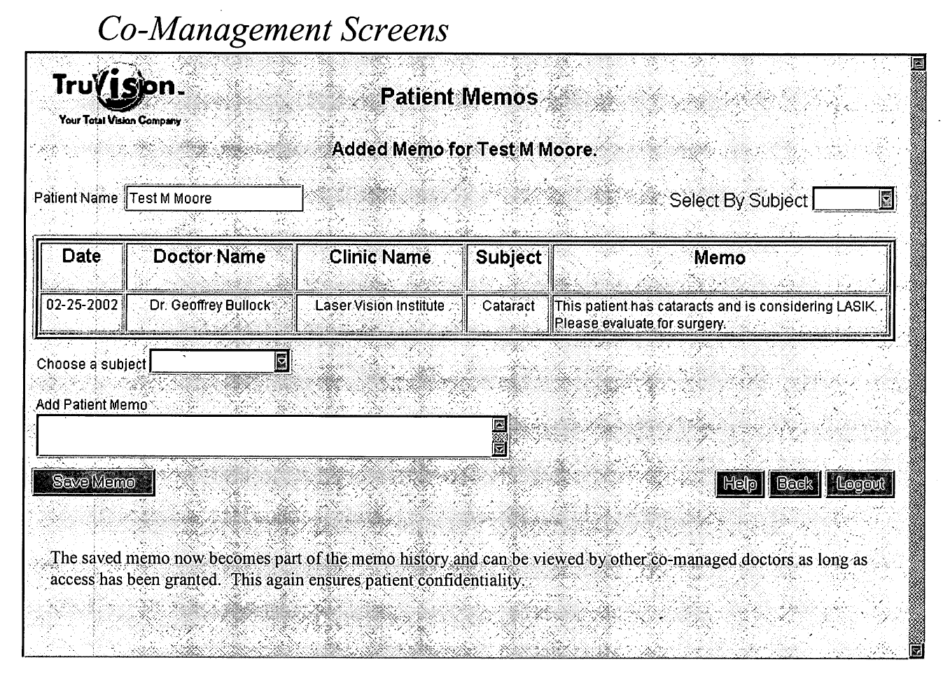

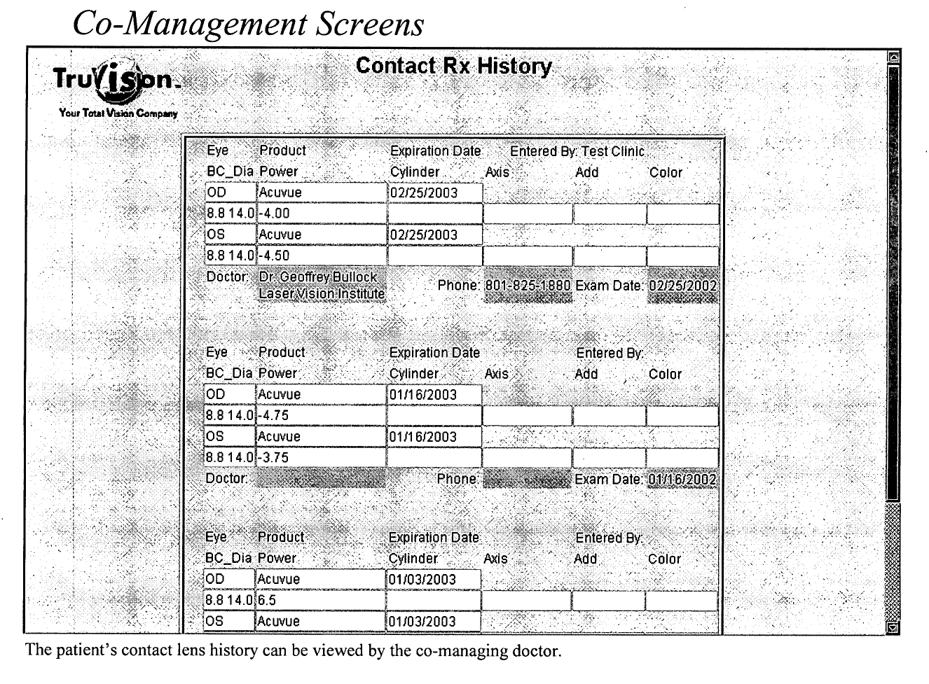

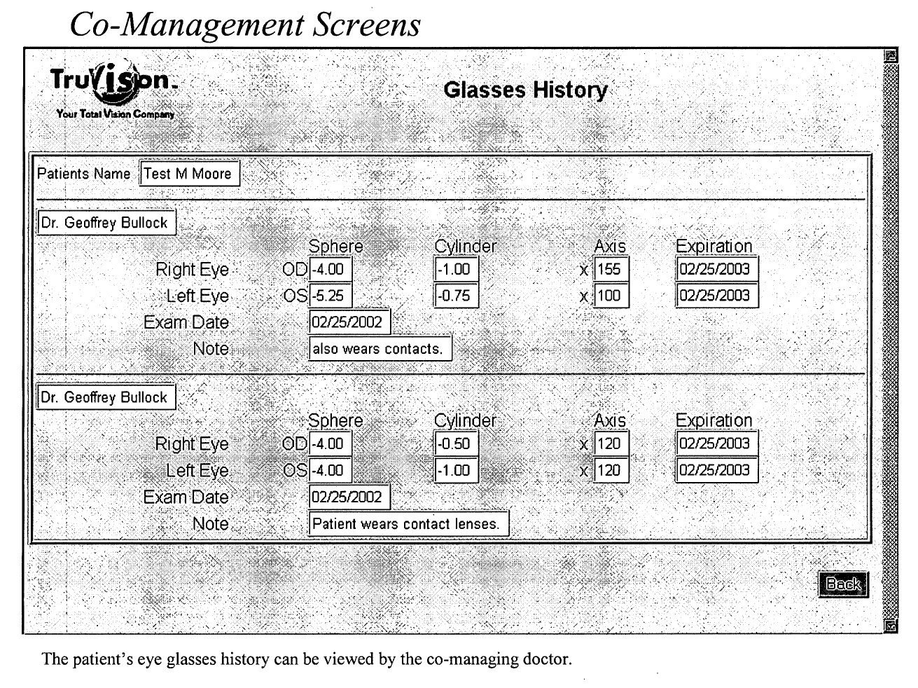

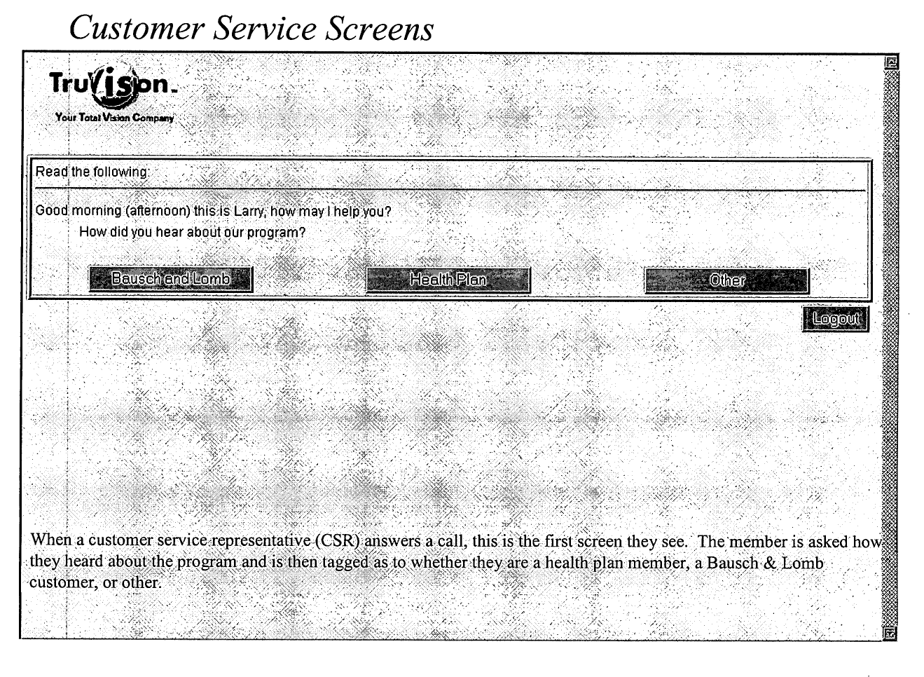

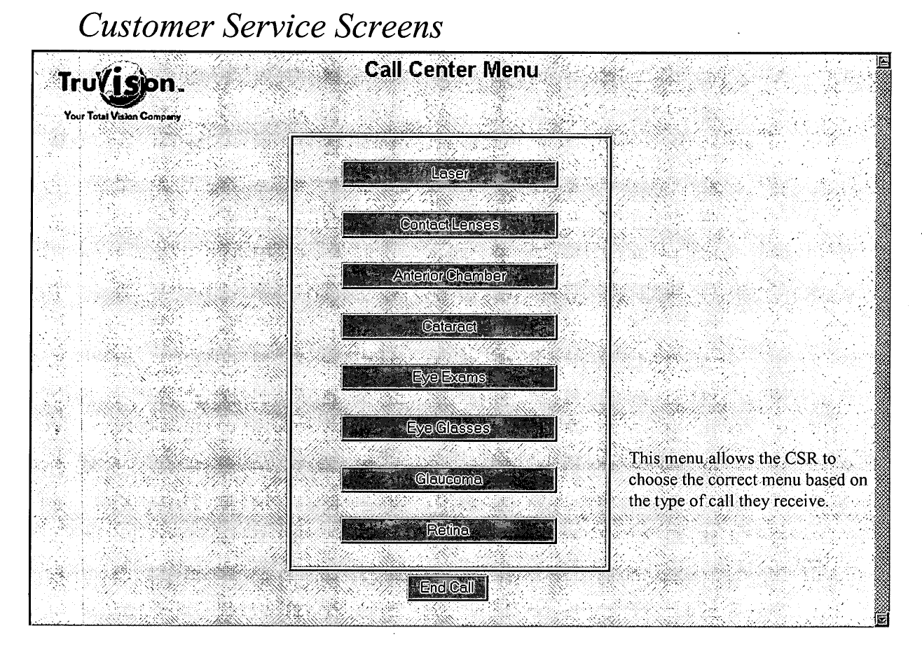

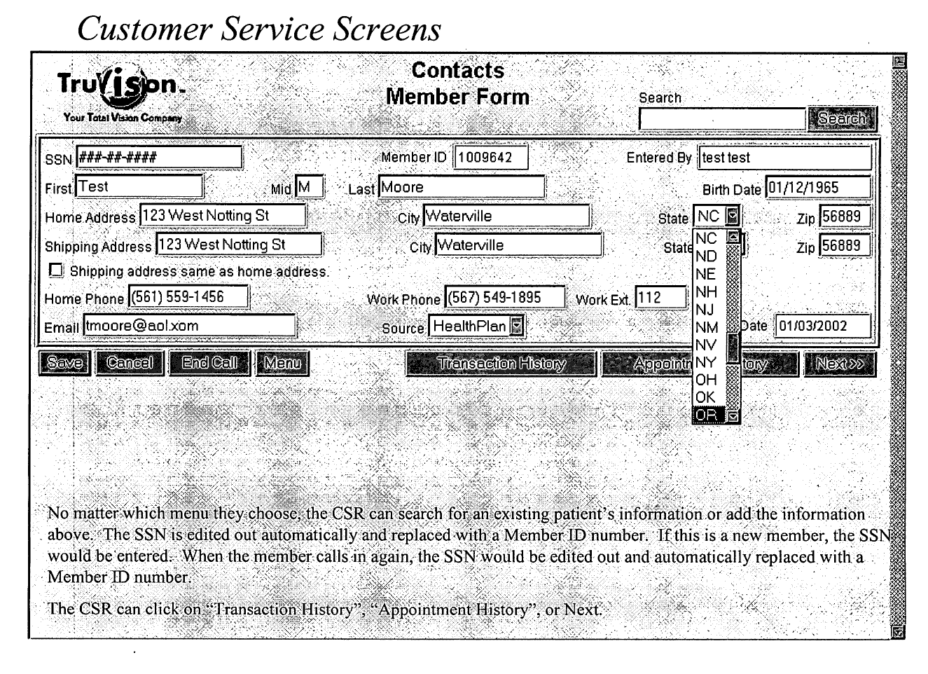

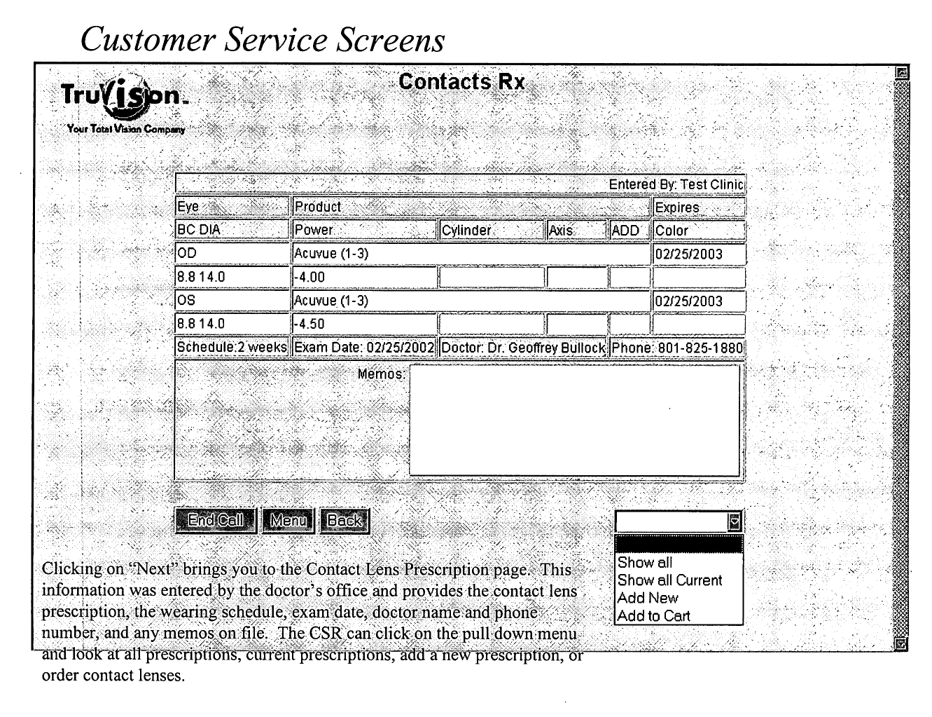

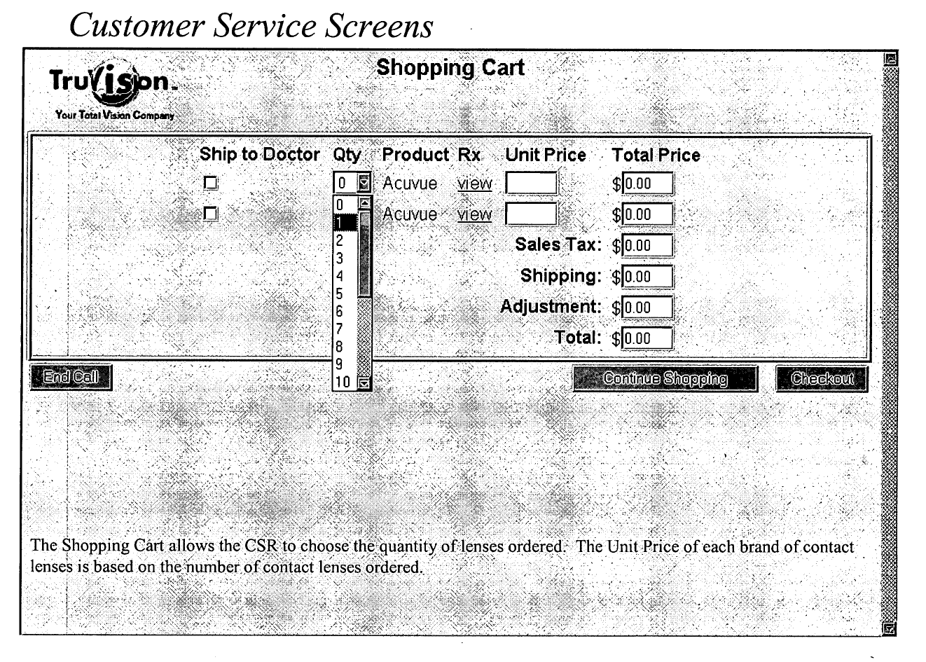

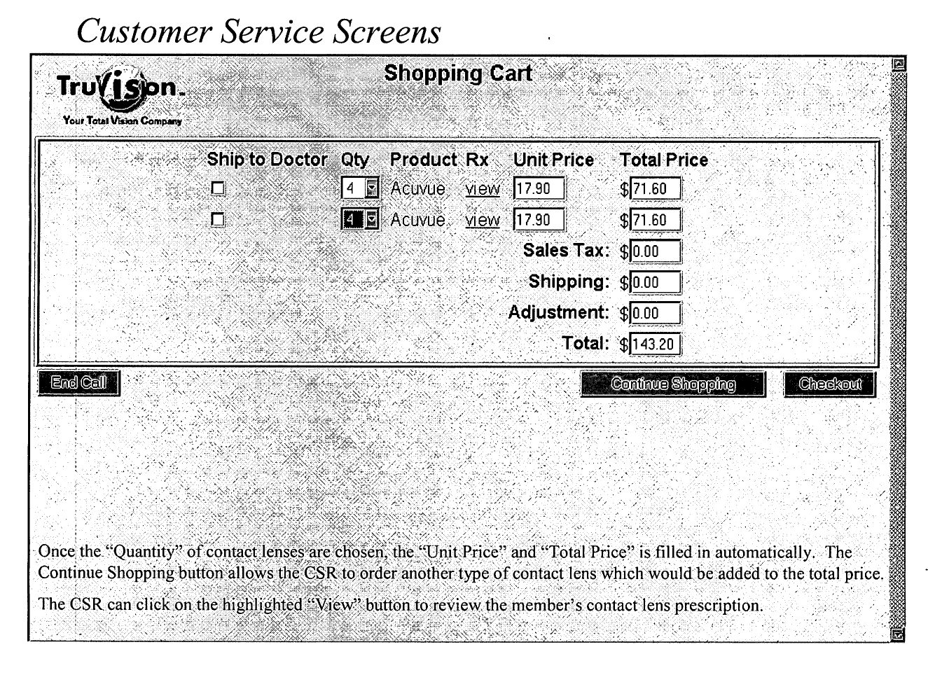

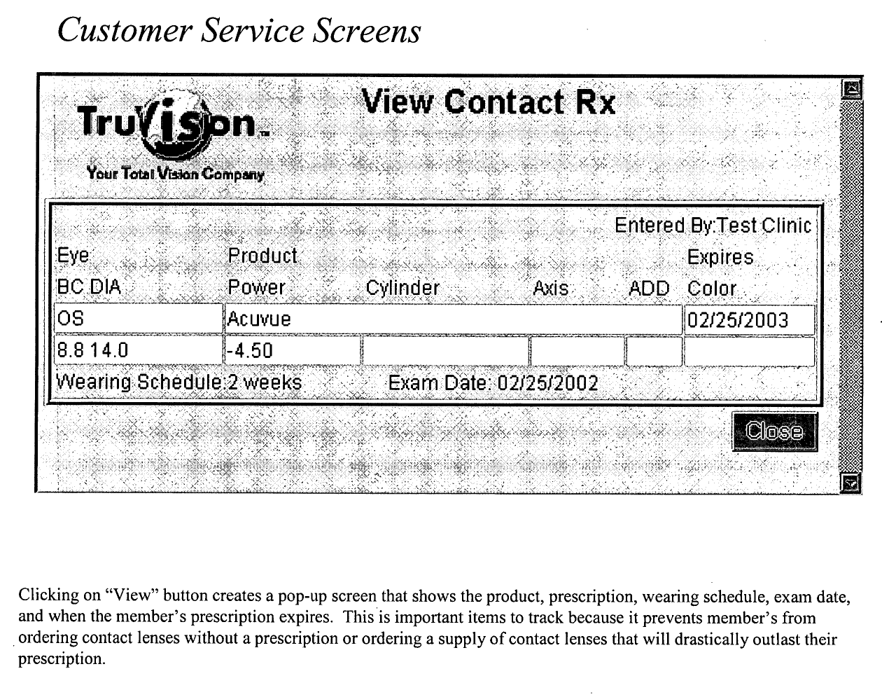

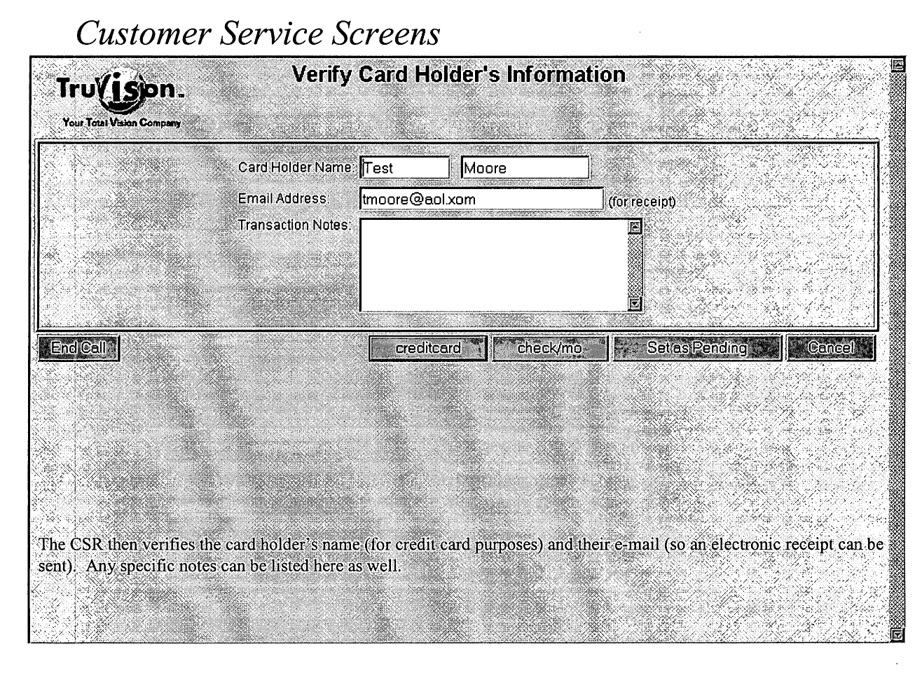

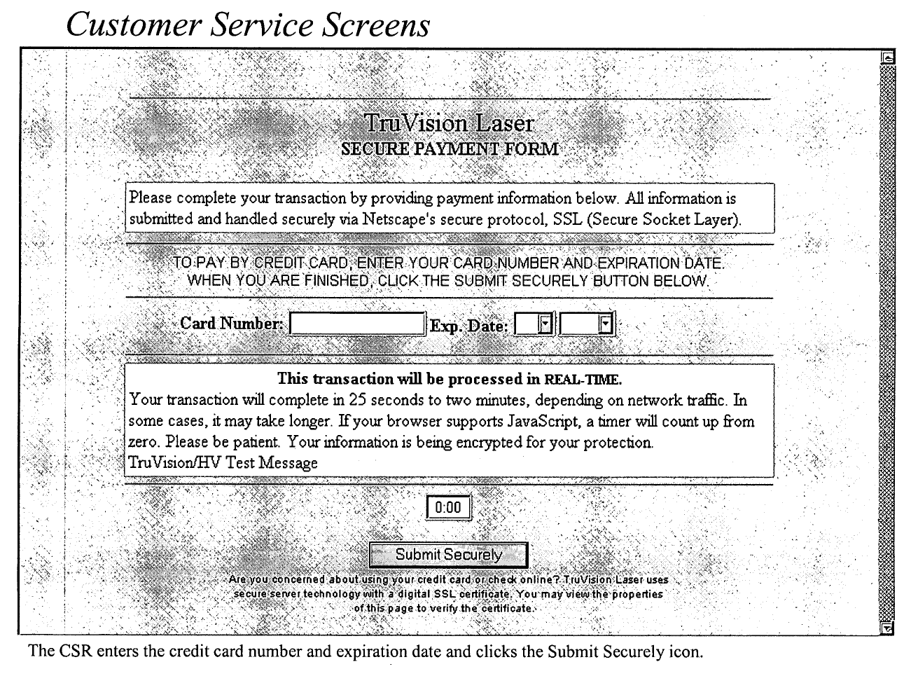

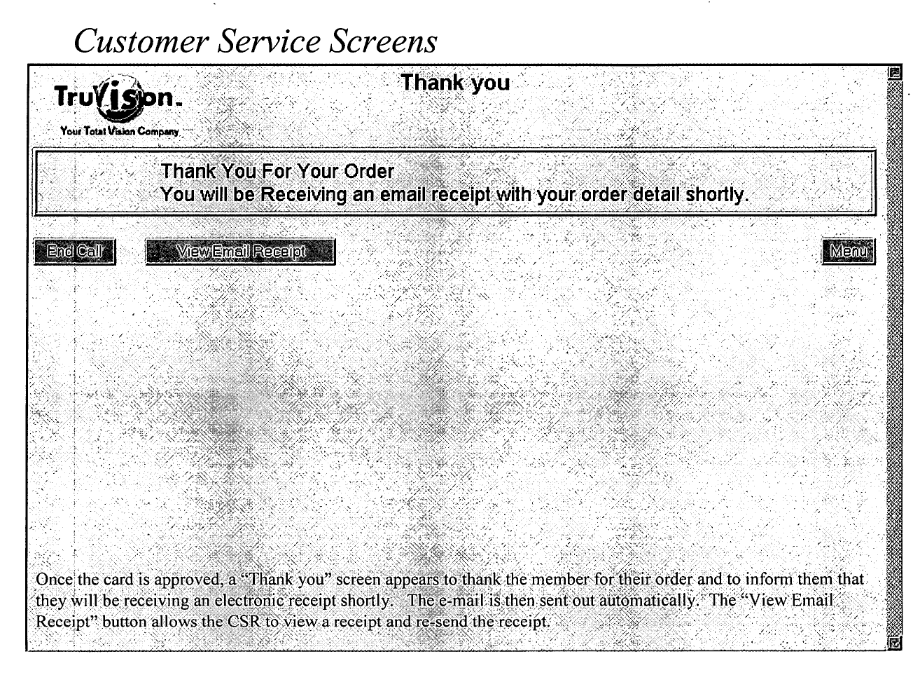

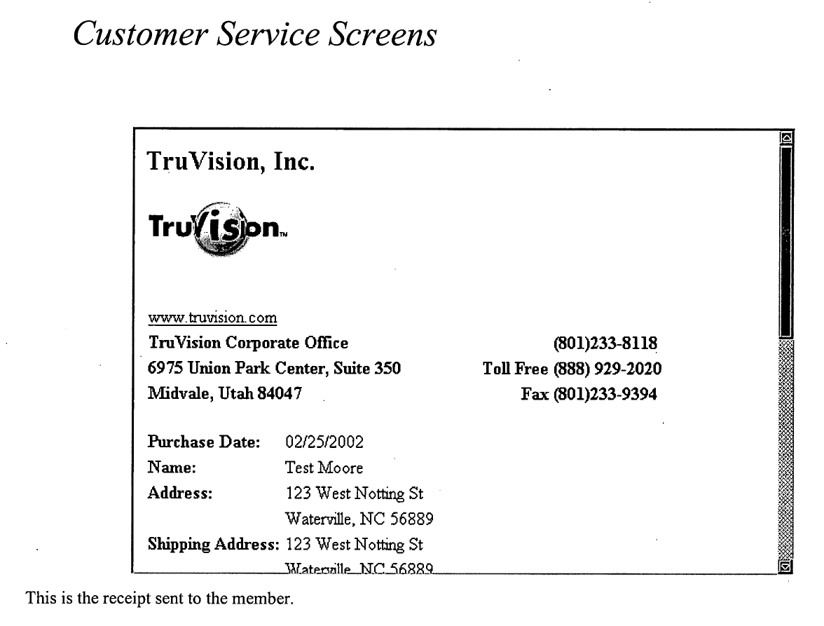

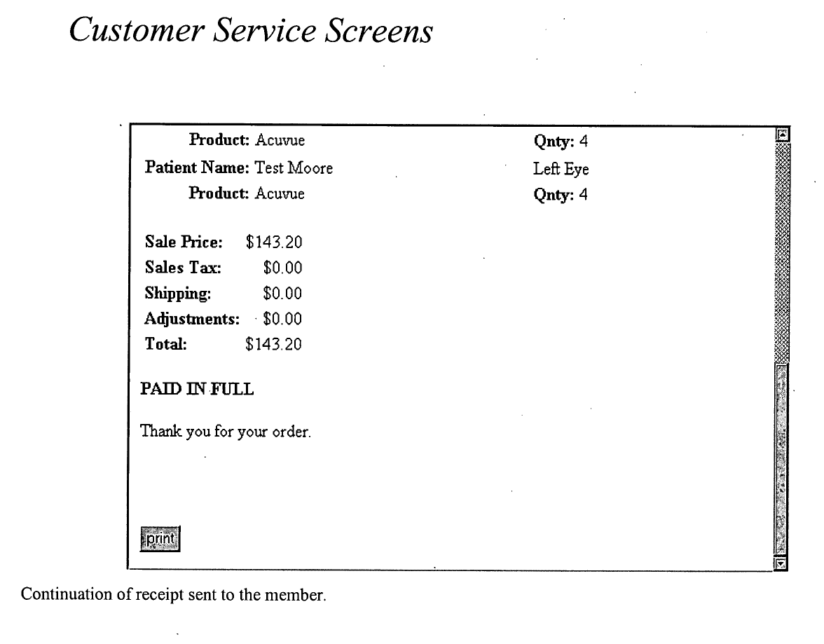

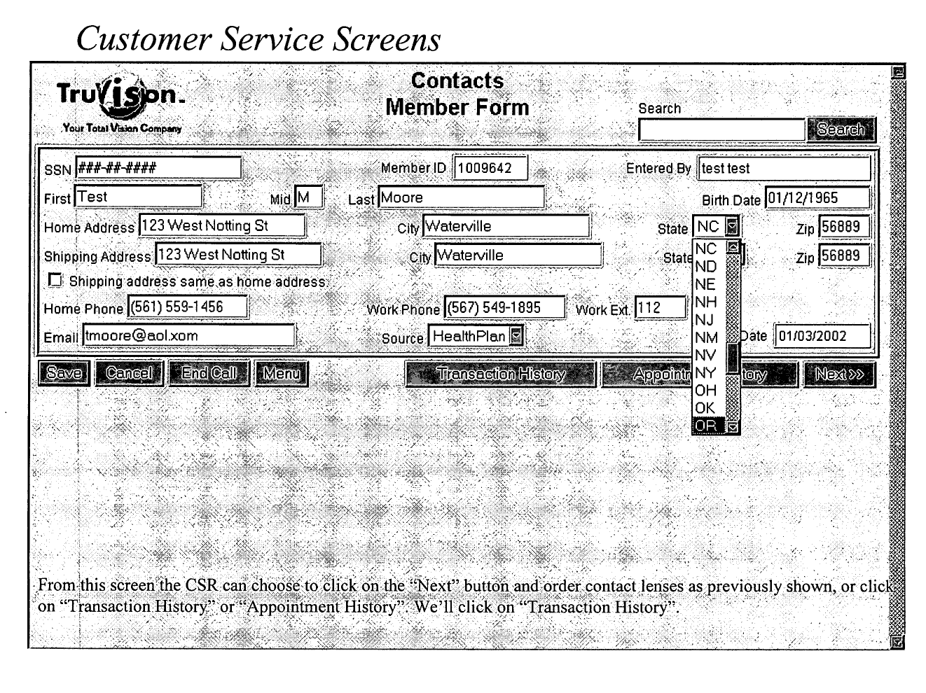

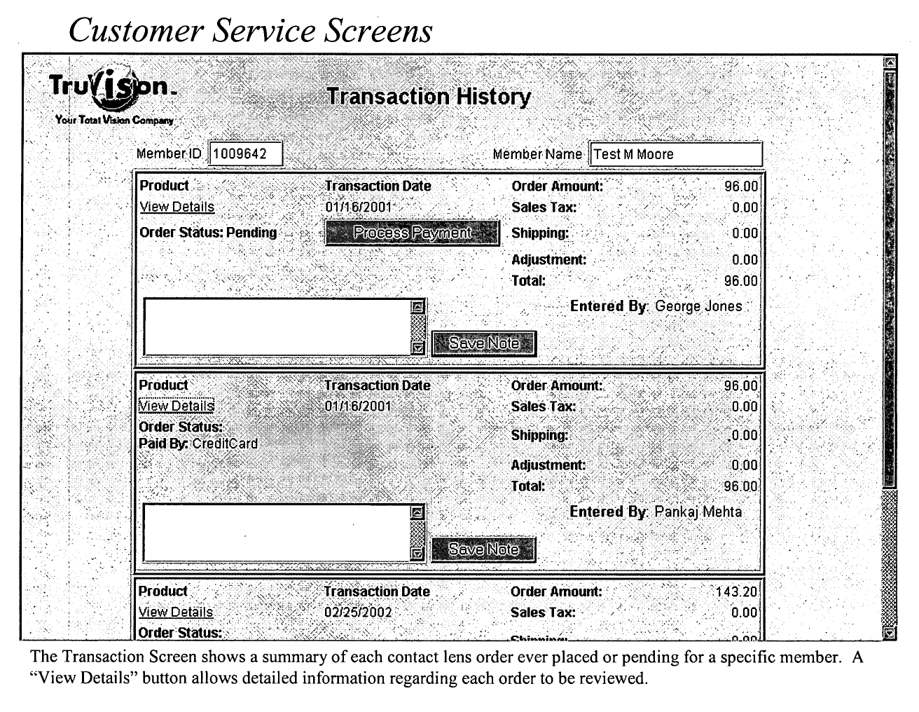

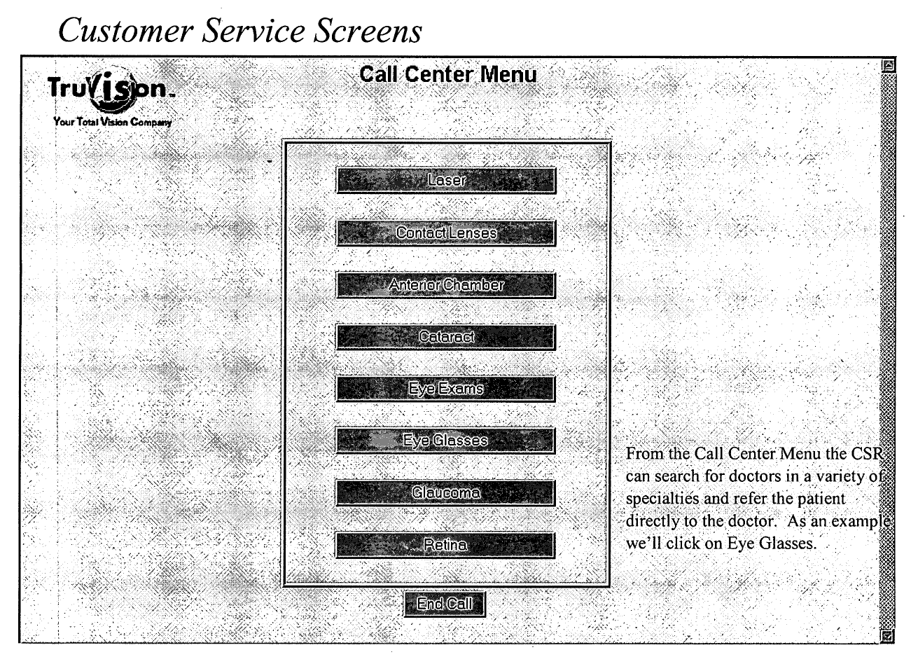

### CROSS-REFERENCE TO RELATED APPLICATIONS

This application is a non-provisional application claiming the benefit of U.S. Provisional Patent Application No. 60/360,795, file Mar. 1, 2002, titled Methods and Apparatus for Facilitating the Provision of Services, which is hereby incorporated by reference in its entirety as though fully set forth herein.

### BACKGROUND OF INVENTION

1. Field of the Invention

This invention is directed toward business models and Web-based systems for providing interactive web-based services between the company and optometrists/ophthalmologists. This web-based system could also be used to connect a wide range of business professionals in a variety of industries. “Web-based systems” include systems that comprise one or more sites on a global network (e.g., one or more sites on the World Wide Web portion of the Internet).

2. Background Art

The vision industry generates revenues in excess of $20 billion per year. Fifty-one percent of the American population has vision correction needs through products and services including, but not limited to, eyeglasses, contact lenses, and laser vision correction. Such a large market with an extraordinary revenue stream provides a health incentive for entrepreneurial business people to offer better services to health care providers, doctors, and patients.

Currently there are no known companies using a web-based application to this degree to increase the co-management model between the company, patients, members, optometrists and ophthalmologists.

The closest model to mimic a portion of the above business model is the “Optometric Co-Management Model.” This model requires that ophthalmologists foster relationships with optometrists and rely on optometric referrals for their patient base. Optometrists receive a large co-management fee and provide post-operative visits for the patients. This model traditionally charges the highest fee for laser vision correction. This model has worked well in the past, but does not allow for a reduction in the laser vision correction price due to the co-management fees involved. It also does not encourage referrals back to the optometrist for conditions the patient may incur such as Glaucoma, Cataracts, eye exams, etc. It also does not use a web-based system of any kind.

### SUMMARY OF INVENTION

The present invention represents a new and innovative business model and Web-based system for various service industries. In this model, a services facilitator establishes multi-year contracts with optometrists/ophthalmologists to gain access to their members and offer them services such as referrals for various vision problems that may occur, on-line entering of contact lens and eyeglass prescriptions, automatic contact lens orders and re-orders via the web that are shipped directly to the patient's home via the doctor's contact lens prescription, the ability to view and update prescriptions, and other administrative tasks directly from their office. These services are offered to all parties with no premiums (e.g. at no cost). The services facilitator handles the marketing to the members and the development and contracting of the services provider network. This is tied together through the services facilitator complete customer service center. The services facilitator's interactive database system is another feature of the present invention. The services facilitator's systems link the customer service center, organizations, members, and service providers to a central service and administrative center.

### INVENTION DETAILS

There are four portions of the invention that encompass the call center, the clinic (optometrists/ophthalmologists), doctor co-management, and contact lens mail-order. The following are flow charts and their accompanying explanations.

[image]

This application includes the current laser scheduling abilities, as referenced in application No. 60/266,206, which is hereby incorporated by reference in its entirety as though fully set forth herein, along with new applications that include the ability to schedule exams for eyeglass, glaucoma, anterior chamber, cataract, and retina exams. This application handles everything that can be controlled from the company's centralized call center. A new application to place contact lens orders will be created to mimic the functionality of the company's current Access application, including a new module that will allow the system to log and track orders received, orders placed, and payments received. The new application also has a new searching mechanism to locate clinics by proximity to a patient based on zip codes, city, or state name. The following is an outline of those items that can be handled from the call center.

Exam Scheduling—Members can call the company's toll-free telephone number and search for a qualified doctor. The search for the doctor will be based on zip code, city, or state and on doctor specialty. The patient can then schedule for items including, but not limited to, the Anterior Chamber, Retina, Contact Lenses, Glaucoma, Cataracts, Laser, Eye Exams, Eyeglasses. The search will provide the three closest doctors based on the search criteria and allow the member to choose the doctor they wish to visit. The display will provide doctor information (name, address, and biographical information) and link to that doctor's schedule information. The system will log referrals to doctors and the date and time of their referral visit.

Prescriptions—Customer Service Representatives (CSR) will have the ability to view all current patient prescriptions or add a new prescription. Once prescriptions are entered into the system they become non-editable. The optometrist/ophthalmologist will also have the ability to add prescriptions for specific patients. CSRs will have the ability to select multiple prescriptions to use in placing an order (e.g. different prescriptions for different types of contact lenses). The CSRs will have the ability to compute the transaction, submit the order, or continue shopping on behalf of the member. The CSR will also enter credit card information and confirm the order. A memo field is also available anywhere during the transaction. This field will allow CSR input if necessary and is non-editable after entry. As members call the company, CSRs will have the ability to search for that member based on name, order date, or order number. The CSR will also have the ability to search for orders that were not finalized.

E-mail receipts—The system will automatically send an e-mail receipt upon completion of an order that can be used for personal and tax purposes.

Auto-order/referral system—The company's administrative system will automatically notify patients for a number of reasons, two of which are 1) that their prescription is expired and refer them to the a) the closest optometrist/ophthalmologist, b) the optometrist/ophthalmologist that provided them with the last prescription, or c) allow the member to call the company and choose an optometrist/ophthalmologist of their choice and 2) that their prescription will soon run out and that they will need to re-order.

[image]

This application is specific to the optometrist/ophthalmologist clinic (office).

Log-In—The clinic logs onto the company's web-based system using a password that is specific to each clinic.

Clinic Menu—The log-in brings the clinic to the clinic menu. This menu will vary based on the clinic since clinics may have different specialties practiced at that office. The clinic would only see the specialties offered by their clinic.

Schedule Administration—The schedule administration system allows the clinic to add/change/delete the schedules for their clinic that can be used by the company. All clinic information is “real time” so as soon as a change is made, the change appears on the company's administrative system. This allows the clinic to completely control their activity. The system also allows for multiple scheduling in the event a clinic has more than one optometrist/ophthalmologist.

Laser Vision Correction—There will be no change for the clinic in regards to working via the web for the company's laser program.

Prescriptions—The clinic will have the ability to enter new prescriptions for both eyeglasses and contact lenses. It will also provide the ability to view past patient prescriptions. All information will be found based on patient searches by first or last name or patient identification number. The clinic will also have the ability to add patients into the web-based system. The clinic will be able to schedule appointments, add new prescriptions and review the history on all patients tagged to their password and clinic number.

End Key—At the end of each transaction, the clinic can hit the “End Key” which will take them out of the current patient file and send them to the Clinic Menu. This is the starting menu for each clinic and will allow the clinic to proceed to the next patient.

Security—The web-based system provides the necessary standard security to ensure clinics can only access patient information on their own patients, or patients that have been referred to them.

[image]

[image]

[image]

This application is specific to the optometrist's own patients or in a co-managed patient with an ophthalmologist. The application uses the web-based system to manage patients or co-managed patients.

Log-In—The clinic logs onto the company's web-based system using a password that is specific to each clinic.

Doctor Menu—The log-in brings the clinic to the doctor menu. This menu will allow the doctor access to only his own patients or patients that have been referred by another doctor in which that patient will be co-managed. AT this point the doctor can search for a their own patient or for a co-managed patient.

Searching for Their Own Patient

Once a patient is found the clinic can determine whether the patient has a prescription for contact lenses or eyeglasses based on the color scheme of the system. The clinic can enter into the contact lens history or the eyeglass history to view changes in prescriptions over a period of time.

The contact lens and eyeglass screens also allows the clinic to add a new prescription. This prescription is entered in “real-time” on the web-based system so they are accessible to the patient through the call center in case contact lenses or eyeglasses need to be purchased. This provides flexibility for the doctor and the patient.

Searching for a Co-Managed Patient

The clinic can search for a co-managed patient by clinic number or patient ID. Once a co-managed patient is found the clinic can access a wide variety of patient information.

History—The clinic can view the patient's current and past contact lens and eyeglass prescriptions.

Orbscan—An orbscan is a machine that provides a detailed picture or topography of the eye. Many clinics do not have a topographer. By providing this information to the clinic, it provides the clinic with more detailed information and saves money because the clinic doesn't have to provide a new topography or order medical records that include the topography. It also allows two or more doctors the ability to look at the same information to determine the best course of treatment.

Digital Images—The web-based system also stores digital images taken of the retina. This is again valuable due to the reasons listed above under Orbscan.

Patient Memos—In addition to looking at images of the eye, the clinic can review memos placed in the patient's chart. The clinic can add vital information in the “New Memo” section or review past memos. Memos can be accessed based on specific categories such as Anterior Chamber, Glaucoma, Eye Exam, Retina, Cataract, or Eyeglasses.

All memos are non-editable

Each saved memo includes the memo information, the date the memo was added, the clinic number and the doctor number.

[image]

This application is specific to the TruVision call center taking a contact lens order via the phone or internet. The system will allow Customer Service Representatives (CSRs) to find an existing member or add a new member to the database.

Existing Member

Once an existing member is found they can view their most current prescription, all non-expired prescriptions, and all their expired prescriptions. Once a current prescription is found, the member can order new contact lenses.

If a current prescription is not on record, a new prescription can be entered and the order taken. The call center would then contact the member's current physician to collect the prescription, or have the member fax the prescription to the call center. The order would stay in a “pending” mode until the prescription is obtained.

The members name, address, e-mail address, payment information and total amount to be charged collected and verified.

Payment is collected.

Contact lenses are shipped directly to the member's home, or other designated, address.

In the event a prescription has expired, the system would return them to the main menu so the member could be referred back to the referring physician for an exam.

New Member

The process is the same for new members, except member information must first be placed in the system. Once this information is entered, the process as described above would take place.

Optometrists are looking for a way to provide their patients with the convenience they want without loosing access to that patient. TruVision's web-based system allows the doctor to offer their patients a mail-order contact lens program, discounts on eyeglasses, co-management and other services with the knowledge that the patient will be referred back to them for eye exams or other professional services. It also ensures that prescriptions are correct and up-to-date when purchasing contact lenses or eyeglasses.

What is claimed is:

1. A method of facilitating the provision of services to individuals, said method comprising the steps of
(a) establishing a services facilitator;
(b) establishing a first information-sharing relationship between said services facilitator and an organization having a plurality of members, wherein at least some of said plurality of members need certain services;
(c) establishing a second information-sharing relationship between said services facilitator and at least one services provider that provides said certain services;
(d) fielding at least one inquiry from at least one member of said plurality of members; and
(e) referring said at least one member to said at least one services provider based upon said at least one inquiry.

2. The method of claim 1 wherein said at least one services provider is selected from the group consisting of optometrists and ophthalmologists.

3. A method of facilitating the provision of health services to individuals, said method comprising the steps of:
(a) establishing a health services facilitator;
(b) establishing a first information-sharing relationship between said health services facilitator and an organization having a plurality of members, wherein at least some of said plurality of members need certain health services;
(c) establishing a second information-sharing relationship between said health services facilitator and at least one health services provider that provides said certain health services;
(d) fielding at least one inquiry from at least one member of said plurality of members;
(e) referring said at least one member to said at least one health services provider based upon said at least one inquiry; and
(f) administering a Web-based system that links said health services facilitator to said at least one health services provider.

4. A method of receiving and processing information in real time over a network, said method comprising the steps of
establishing a site on a global communication network;
providing a central server connected to said site on said global communication network, said central server accessing a dynamic database;
recognizing an active scheduler;
prompting said active scheduler with information stored by said central server to collect information for a plurality of fields within said dynamic database;
receiving said collected information from said active scheduler;
processing said collected information by said central server; and
updating said dynamic database to reflect said collected information prior to recognizing a second active scheduler.
